(19) United States
(12) Patent Application Publication
(10) Pub. No.: US 2026/0093434 A1
(43) Pub. Date: Apr. 2, 2026

(54) CONTROL METHOD AND DISPLAY SYSTEM

(71) Applicant: SEIKO EPSON CORPORATION, Tokyo (JP)

(72) Inventors: Hirohiko KIHARA, MATSUMOTO-SHI (JP); Katsuyoshi YAMAGUCHI, MATSUMOTO-SHI (JP)

(21) Appl. No.: 19/343,657

(22) Filed: Sep. 29, 2025

(30) Foreign Application Priority Data
Sep. 30, 2024 (JP) 2024-170128

(51) Int. Cl. G06F 3/14

(52) U.S. Cl. CPC G06F 3/1423

(57) ABSTRACT

A display system includes a first device; a second device; and a display device configured to communicate with the first device via the wired cable, configured to communicate with the second device by wireless communication, and configured to display an image on a display region, wherein the display device establishes first communication with the first device via the wired cable, when second communication between the second device and the display device is requested from the second device while an image is displayed on the display region, the display device transmits information indicating that the second communication was requested to the first device via the wired cable, and when information indicating that the second communication was approved is received from the first device via the wired cable, the display device establishes the second communication by wireless communication.

The present application is based on, and claims priority from JP Application Serial Number 2024-170128, filed September 30, 2024, the disclosure of which is hereby incorporated by reference herein in its entirety.

### BACKGROUND

### 1. Technical Field

The present disclosure relates to a control method and a display system.

### 2. Related Art

In related art, in order for a device such as a computer to display an image on a display device such as a projector, communication is established between the device such as a computer and the display device. For example, JP-A-2018-152663 discloses that a projector displays an image including an identification code on a projection surface in response to a predetermined operation such as turning on power, and a user of the projector inputs the identification code displayed on the projection surface into an information terminal, thereby causing the projector to establish communication with the information terminal.

However, when a plurality of devices are connectable to one display device, the following problem arises. Specifically, a situation is conceivable in which, while the display device is displaying an image based on image data transmitted from a device with which communication with the display device has already been established, a device with which communication with the display device has not been established requests communication with the display device. In this situation, if the display device executes a predetermined operation and displays an image including the identification code, there is a problem in that the display of an image based on image data transmitted from the device with which communication is established is interfered with.

### SUMMARY

A control method according to one aspect of the present disclosure is a control method of a display system including a first device, a second device, and a display device that is configured to communicate with the first device via one or more wired cables, that is configured to communicate with the second device by wireless communication, and that is configured to display an image on a display region, the control method including establishing, by the display device, first communication with the first device via the one or more wired cables; when second communication is requested from the second device while an image is displayed on the display region, transmitting, by the display device, information indicating that the second communication between the second device and the display device was requested to the first device via the one or more wired cables; and when receiving information indicating that the second communication was approved from the first device via the one or more wired cables, establishing, by the display device, the second communication by wireless communication.

A display system according to one aspect of the present disclosure includes a first device; a second device; and a display device configured to communicate with the first device via one or more wired cables, configured to communicate with the second device by wireless communication, and configured to display an image on a display region, wherein the display device establishes first communication with the first device via the one or more wired cables, when second communication between the second device and the display device is requested from the second device while an image is displayed on the display region, the display device transmits information indicating that the second communication was requested to the first device via the one or more wired cables, and when information indicating that the second communication was approved is received from the first device via the one or more wired cables, the display device establishes the second communication by wireless communication.

### BRIEF DESCRIPTION OF THE DRAWINGS

FIG. 1 is a diagram showing a display system 1 according to a first embodiment.

FIG. 2 is a diagram showing an example of a configuration of a PC 10.

FIG. 3 is a diagram showing an example of a configuration of a smartphone 20.

FIG. 4 is a diagram showing an example of a configuration of a projector 30.

FIG. 5 is a sequence diagram for explaining an example of an operation of the display system 1.

FIG. 6 is a flowchart showing an example of an operation of the projector 30.

FIG. 7 is a flowchart showing an example of a process for when a communication request is received.

FIG. 8 is a flowchart showing an example of a process for when authorization request information is received.

FIG. 9 is a diagram showing an example of a communication determination image CW.

FIG. 10 is a flowchart showing an example of a process for when a communication request is received according to a first modification.

FIG. 11 is a flowchart showing an example of an authorization request information transmission process.

FIG. 12 is a flowchart showing an example of a process for when authorization request information is received in the first modification.

FIG. 13 is a flowchart showing an example of an operation of the projector 30 in a second modification.

FIG. 14 is a flowchart showing an example of a process for when image data is received.

FIG. 15 is a flowchart showing an authorization request information transmission process according to the second modification.

FIG. 16 is a flowchart showing an example of an operation of the projector 30 in a third modification.

FIG. 17 is a flowchart showing an example of an operation of a process for when image data is received according to the third modification.

FIG. 18 is a diagram for explaining a state immediately before changing to a hold mode.

FIG. 19 is a diagram for explaining a state after changing to the hold mode.

FIG. 20 is a flowchart showing an authorization request information transmission process according to the third modification.

### DESCRIPTION OF EMBODIMENTS

Hereinafter, embodiments of the present disclosure will be described with reference to the drawings. In the drawings, the dimensions and scales of the sections are different from the actual ones as appropriate. In addition, the embodiments described below are preferred specific examples of the present disclosure, and thus various technically preferable limitations are added thereto, but the scope of the present disclosure is not limited to these embodiments unless there is a description to particularly limit the present disclosure in the following description.

### 1. FIRST EMBODIMENT

### 1-1. Overview of first embodiment

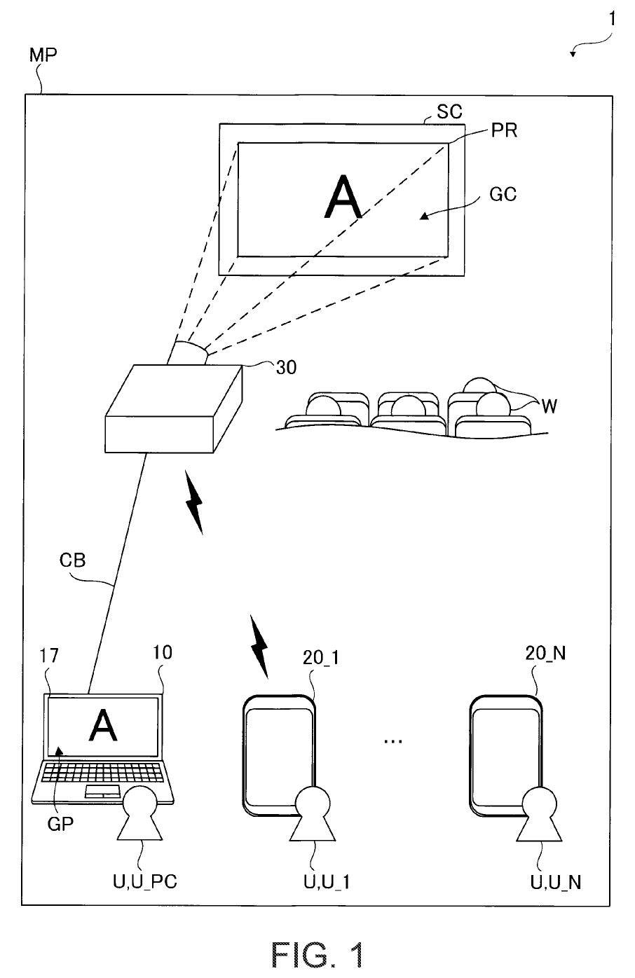

FIG. 1 is a diagram showing a display system 1 according to a first embodiment. The display system 1 is a system that projects an image GC on a projection region PR of a projection surface SC viewed by one or a plurality of spectators W in a venue MP, and that allows any of two or more presenters U to give an explanation regarding the image GC. The venue MP is a place where an event in which the spectators W gather is held, and may be either an indoor place or an outdoor place. The spectator W is a specific or unspecified person. However, the spectator W may not be present, and the presenter U other than the presenter U who is currently giving an explanation among the two or more presenters U may be a temporary spectator. The event is, for example, a conference, a lecture, a class, or the like. In the present embodiment, it is assumed that two or more presenters U sequentially give explanations.

As shown in FIG. 1, the display system 1 includes one PC 10, one or more (N) smartphones 20, and a projector 30. PC is an abbreviation for personal computer. The PC 10 is operated by a presenter U_PC. An i-th smartphone 20_i among the N smartphones 20 is operated by an i-th presenter U_i among N persons. The reference symbol i is an integer from 1 to N. In the following description, the presenter U_PC and presenters U_1 to U_N may be described as a presenter U without distinction. In the present embodiment, for the sake of simplicity of description, the presenter U will be described with respect to the image GC projected on the projection region PR, but a person who operates the PC 10 or a person who operates the smartphone 20_i and a person who explains the image GC may be different persons. The one PC 10 and the N smartphones 20 are examples of "a plurality of devices". Projecting an image is an example of "displaying an image". The projector 30 is an example of a "display device". The projection region PR is an example of a "display region". The display system 1 may include N PCs instead of the N smartphones 20.

In the following description, when the same type of elements are distinguished, reference symbols are used such as a smartphone 20_1 and a smartphone 20_2. On the other hand, when the same type of elements are not distinguished, only a common number of the reference symbols is used as in the smartphone 20.

The projector 30 can communicate with the PC 10 and the N smartphones 20. Specifically, the projector 30 is capable of communicating with the PC 10 via a wired cable CB. The projector 30 can communicate with the N smartphones 20 by wireless communication. Examples of wireless communication include Wi-Fi, Bluetooth, and ZigBee. Wi-Fi and Bluetooth are registered trademarks. However, the projector 30 and each of the N smartphones 20 may be able to communicate with each other via a relay device such as a wireless router, or may be able to communicate with each other via a network such as a LAN, a WAN, or the Internet. LAN is an abbreviation for local area network. The wired cable CB is an example of "one or more wired cables".

As in the display system 1, the following two situations are examples of a situation in which wired communication and wireless communication are mixed as an aspect of communication with the projector 30. A first situation in which wired communication and wireless communication are mixed is a case where the display system 1 includes a device that does not generally perform communication via the wired cable CB, such as the smartphone 20. A second situation in which wired communication and wireless communication are mixed is a case where the venue MP is vast and the projector 30 cannot be connected by the wired cable CB.

The display system 1 is applied to, for example, the following two situations. In a first situation to which the display system 1 is applied, the event is a conference, and the presenter U_PC is an organizer of the conference and gives an overall description of the conference. Each of the presenters U_i, whose reference symbol i is 1 to N, gives a description according to the agenda of each presenter. In a second situation to which the display system 1 is applied, the event is a class, the presenter U_PC is a teacher who is in charge of the class, and each presenter U_i, whose reference symbol i is 1 to N, is a participant who takes the class. The teacher who is the presenter U_PC explains the content of an assignment given to the participant in the class before this class. Each of the participants, who are presenters U_i, whose reference symbol i is 1 to N, explains an answer to the assignment. In the following, for ease of understanding, it is assumed that the presenter U who makes a presentation first is the presenter U_PC, the presenter U_1 makes a presentation next to the presenter U_PC, all the presenters U_i, whose reference symbol i is 1 to N-1, make a presentation, and a presenter U_i+1 makes a presentation next to the presenter U_i.

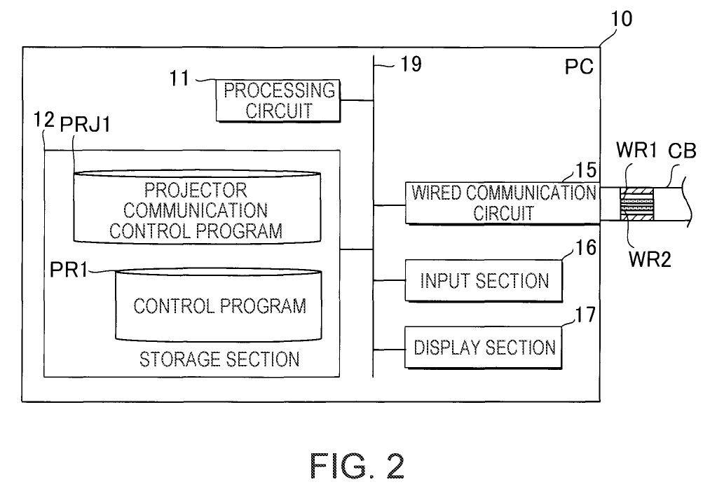

The configurations of the PC 10, the smartphone 20, and the projector 30 will be described with reference to FIGS. 2, 3, and 4.

FIG. 2 is a diagram showing an example of a configuration of the PC 10. The PC 10 includes at least one processing circuit 11, a storage circuit 12, a wired communication circuit 15, an input section 16, and a display section 17. The processing circuit 11, the storage circuit 12, the wired communication circuit 15, the input section 16, and the display section 17 are connected to each other by a bus 19 for communicating information.

The processing circuit 11 is a processing circuit such as a CPU or an FPGA. CPU is an abbreviation for central processing unit. FPGA is an abbreviation for field programmable gate array. The processing circuit 11 may be configured by one or more processors.

The storage circuit 12 is configured by a magnetic storage device, a flash ROM, or the like. The storage circuit 12 is a recording medium readable by the processing circuit 11, and stores a plurality of programs including a projector communication control program PRJ1 and a control program PR1 executed by the processing circuit 11, various kinds of information used by the processing circuit 11, and the like. The projector communication control program PRJ1 is an application program for controlling an operation of the PC 10 in the display system 1. For example, the PC 10 downloads the projector communication control program PRJ1 from a server managed by a developer of the projector 30. The control program PR1 is a system program including an OS of the PC 10. OS is an abbreviation for operating system.

The wired communication circuit 15 is an interface connected to an external computer or the like, and includes a connector and an interface circuit conforming to a standard such as USB, IEEE1394, or Ethernet. USB is an abbreviation for universal serial bus. IEEE is an abbreviation for institute of electrical and electronics engineers. Ethernet is a registered trademark.

As shown in FIG. 2, the wired cable CB is electrically connected to the wired communication circuit 15. FIG. 2 shows a part of the inside of the wired cable CB. As shown in FIG. 2, the wired cable CB includes a first wiring WR1 for transferring image data and a second wiring WR2 for transmitting control data. For example, when the wired cable CB operates in an alternate mode of USB Type-C, the first wiring WR1 is a wiring that transmits image data conforming to HDMI or the like, and the second wiring WR2 is a pair of signal lines that transmit differential signals D+ and D-. HDMI is a registered trademark and is an abbreviation for high-definition multimedia interface.

The input section 16 is a device for the presenter U_PC to input information. The input section 16 is, for example, a mouse and a keyboard.

The display section 17 is a device that displays an image based on image data transmitted by the processing circuit 11. For example, the display section 17 is an LCD or an organic EL display. LCD is an abbreviation for liquid crystal display. EL is an abbreviation for electro luminescence. The input section 16 and the display section 17 may be integrated. A configuration in which the input section 16 and the display section 17 are integrated is, for example, a touchscreen.

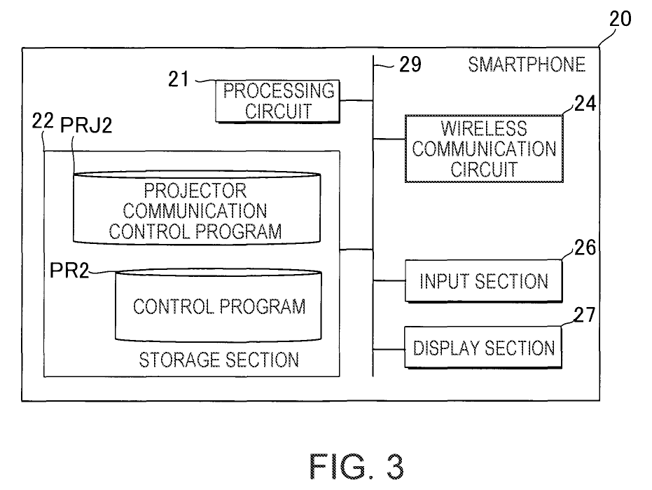

FIG. 3 is a diagram showing an example of a configuration of the smartphone 20. The smartphone 20 includes at least one processing circuit 21, a storage circuit 22, a wireless communication circuit 24, an input section 26, and a display section 27. The processing circuit 21, the storage circuit 22, the wireless communication circuit 24, the input section 26, and the display section 27 are connected to each other by a bus 29 for communicating information.

The processing circuit 21 is a processing circuit such as a CPU or an FPGA. The processing circuit 21 may be configured by one or more processors.

The storage circuit 22 is configured by a magnetic storage device, a flash ROM, or the like. The storage circuit 22 is a recording medium readable by the processing circuit 21, and stores a plurality of programs including a projector communication control program PRJ2 and a control program PR2 executed by the processing circuit 21, various kinds of information used by the processing circuit 21, and the like. The projector communication control program PRJ2 is an application program for controlling an operation of the smartphone 20 in the display system 1. The projector communication control program PRJ1 and the projector communication control program PRJ2 are programs having the same functions. The projector communication control program PRJ1 and the projector communication control program PRJ2 are different from each other in that the projector communication control program PRJ1 is built for the PC 10 and the projector communication control program PRJ2 is built for the smartphone 20. In the following description, the projector communication control program PRJ1 and the projector communication control program PRJ2 may be referred to as a projector communication control program PRJ without being distinguished from each other. For example, the smartphone 20 downloads the projector communication control program PRJ2 from a server managed by a developer of the projector 30. The control program PR2 is a system program including an OS of the smartphone 20. The projector communication control program PRJ is an example of a "program for controlling communication of a display device".

The wireless communication circuit 24 is hardware including a communication circuit for performing wireless communication with other devices such as the projector 30. The wireless communication circuit 24 may include, for example, a connector or an antenna corresponding to a communication standard such as wireless communication via Wi-Fi, infrared communication, and Bluetooth, and a communication circuit. Wi-Fi and Bluetooth are registered trademarks.

The input section 26 is a device for the presenter U_i to input information for each integer i from 1 to N. The input section 26 is, for example, a physical button.

The display section 27 is a device that displays an image based on image data transmitted by the processing circuit 21. For example, the display section 27 is an LCD or an organic EL display. LCD is an abbreviation for liquid crystal display. EL is an abbreviation for electro luminescence. The input section 26 and the display section 27 may be integrated. A configuration in which the input section 26 and the display section 27 are integrated is, for example, a touchscreen.

In the following description, each element of the smartphone 20_i may be denoted by a reference symbol "_i". For example, the display section 27 included in the smartphone 20_i may be referred to as a display section 27_i.

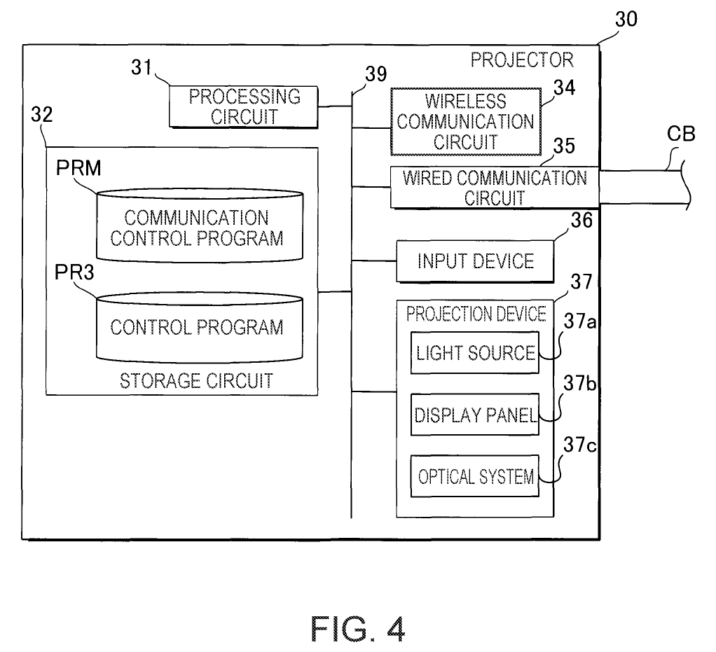

FIG. 4 is a diagram showing an example of a configuration of the projector 30. The projector 30 includes at least one processing circuit 31, a storage circuit 32, a wireless communication circuit 34, a wired communication circuit 35, an input device 36, and a projection device 37. The processing circuit 31, the storage circuit 32, the wireless communication circuit 34, the wired communication circuit 35, the input device 36, and the projection device 37 are connected to each other by a bus 39 for communicating information.

The processing circuit 31 is a processing circuit such as a CPU, a system on chip (SoC), or an FPGA. The processing circuit 31 may be configured by one or more processors.

The storage circuit 32 is configured by a magnetic storage device, a flash ROM, or the like. The storage circuit 32 is a recording medium that is readable by the processing circuit 31, and that stores a plurality of programs including a control program PR3 and a communication control program PRM, various kinds of information used by the processing circuit 31, and the like. The control program PR3 is a system program including an OS of the projector 30. The communication control program PRM is a program for controlling an operation of the projector 30 in the display system 1.

The wireless communication circuit 34 is hardware including a communication circuit for performing wireless communication with other devices such as the smartphone 20. The wireless communication circuit 34 may include, for example, a connector or an antenna corresponding to a communication standard such as wireless communication via Wi-Fi, infrared communication, and Bluetooth, and a communication circuit.

The wired communication circuit 35 is an interface that is connected to the PC 10 or the like, and that includes a connector and an interface circuit conforming to a standard such as USB, IEEE1394, or Ethernet.

The input device 36 is a device for the presenter U to input information. The input device 36 is a plurality of buttons including, for example, a function list display key, an up key, a down key, a left key, a right key, a determination key, and a cancel key. Alternatively, the input device 36 may be configured by one or more types of devices such as a pointing device and a touchscreen. Alternatively, the projector 30 may communicate with a remote controller including a plurality of buttons described above instead of the input device 36.

The projection device 37 is a device that projects the image GC on the projection region PR based on image data transmitted from the processing circuit 31. The projection device 37 includes a light source 37a, a display panel 37b, and an optical system 37c.

The light source 37a includes a light source such as a halogen lamp, a xenon lamp, an ultra-high pressure mercury lamp, an LED, or a laser light source, and emits red, green, and blue light, respectively. LED is an abbreviation for light emitting diode. The display panel 37b is a light modulation device including three light modulation elements provided corresponding to red, green, and blue. Each of the light modulation elements includes, for example, a transmissive liquid crystal panel, a reflective liquid crystal panel, a digital mirror device, or the like, and generates image light of each color by modulating light of the corresponding color. Image light of each color generated by the display panel 37b is combined by a color combining optical system to become full-color image light. The optical system 37c is a projection optical system including a projection lens and the like that forms and projects full-color image light from the display panel 37b into the image GC on the projection region PR.

The description returns to FIG. 1. In the example shown in FIG. 1, the projector 30 communicates with the PC 10, and an image GP displayed on the display section 17 and the image GC projected on the projection region PR are the same.

In the present specification, the image GP and the image GC being the same means that image data transmitted by the processing circuit 11 to the display section 17 and image data transmitted by the processing circuit 31 to the projection device 37 are the same. Therefore, even when the color reproducibility of the display section 17 and the color reproducibility of the projection device 37 are different from each other, if image data transmitted from the processing circuit 11 to the display section 17 and image data transmitted from the processing circuit 31 to the projection device 37 are the same, the image GP and the image GC are regarded as being the same. Similarly, an image displayed on the display section 27_i of the smartphone 20_i being the same as the image GC for each reference symbol i from 1 to N means that image data transmitted by a processing circuit 21_i to the display section 27_i is the same as image data transmitted by the processing circuit 31 to the projection device 37. Therefore, even when the color reproducibility of the display section 27_i and the color reproducibility of the projection device 37 are different from each other, if the image data transmitted by the processing circuit 21_i to the display section 27_i and the image data transmitted by the processing circuit 31 to the projection device 37 are the same, the image displayed on the display section 27_i and the image GC are regarded as being the same.

### 1-2. In progression of event

During the progress of the event, while the presenter U_PC is explaining about the image GC, there is a request that wants the presenter U_1, who will make a presentation next after the presenter U_PC, to prepare for projection on the projector 30. An example of the preparation for projection is to establish communication between the smartphone 20_1 and the projector 30. Establishing communication means setting a communication path between a PC or a smartphone and a projector before starting data transfer. Establishing communication via the wired cable CB means that a wired communication establishment process is executed corresponding to the wired cable CB, thereby setting a communication path between a PC and a projector. For example, in a case in which the wired cable CB is compliant with USB, communication between the PC 10 and the projector 30 becomes possible by executing USB enumeration, which is an example of the wired communication establishment process, between the PC 10 and the projector 30.

Establishing communication by wireless communication means that the PC 10 or the smartphone 20 logs in to a service for projecting images using the projector 30. Alternatively, establishing communication may be executing a three-way handshake in a case where TCP is used in communication between the PC 10 and the projector 30 or communication between the smartphone 20 and the projector 30. TCP is an abbreviation for transmission control protocol. When communication is established, the smartphone 20 can access the projector 30, and the presenter U can prepare for projection. In the following description, establishing communication between the smartphone 20 and the projector 30 in wireless communication may be described as "the smartphone 20 logs in to the projector 30".

In general, the time during which the presenter U can make an explanation is allocated in advance. In a case where a problem that the smartphone 20_1 cannot log in to the projector 30 occurs, if it takes time to solve the problem, there is a possibility that the time that the presenter U_1 can give an explanation may be shortened. Therefore, the smartphone 20_1 logs in the projector 30 while the presenter U_PC is explaining about the image GC, whereby the presenter U_1 can smoothly progress the explanation after explanation of the presenter U_PC.

As a method of the smartphone 20 logging in to the projector 30, the projector 30 displays an image including an identification code on the projection region PR in accordance with a predetermined operation such as power-on. For each of the reference symbols i from 1 to N, the presenter U_i inputs the identification code displayed on the projection region PR to the smartphone 20_i, and thus the smartphone 20_i logs in to the projector 30.

In order for the smartphone 20_1 to log in to the projector 30, a situation may be considered in which the smartphone 20_1 makes a requests to the projector 30 in order to communicate with the projector 30 while the presenter U_PC is explaining about the image GP. In this situation, if the projector 30 displays an image including the identification codes on the projection region PR, there is a problem that the display of the image GP based on image data transmitted from the PC 10 is interfered with. When the display of the image GP based on image data transmitted from the PC 10 is interfered with, the presenter U_PC cannot proceed with the explanation regarding the image GP. Further, the presenter U_PC needs to explain to the spectators W that an image including an identification code is irrelevant to a content explained by the presenter U_PC.

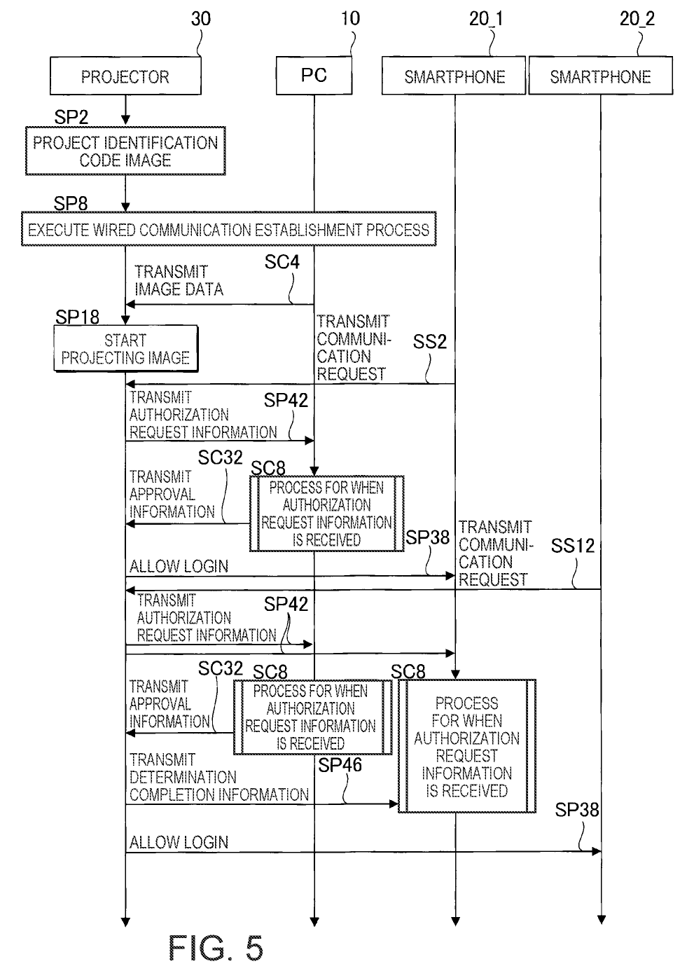

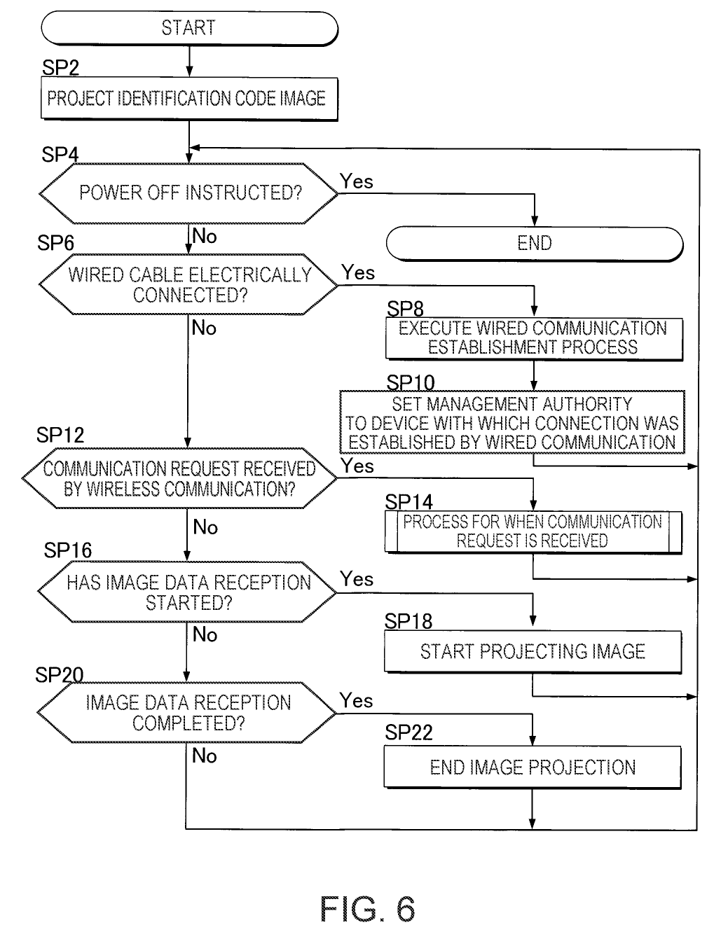

Therefore, in the display system 1 according to the present embodiment, when the projector 30 is requested by the smartphone 20_1 to communicate between the smartphone 20_1 and the projector 30, the projector 30 notifies the PC 10 of authorization request information indicating that this communication has been requested via the wired cable CB. Hereinafter, a request for communication may be referred to as a "communication request." When the authorization request information is received, the PC 10 runs the projector communication control program PRJ1 and, by the function of the projector communication control program PRJ1, outputs information for causing the presenter U_PC to determine whether or not to approve the communication to the display section 17 of the PC 10. Information for causing the presenter U_PC to determine whether or not to approve the communication between the smartphone 20_1 and the projector 30 may be a character string indicating whether or not to approve the communication between the smartphone 20_1 and the projector 30, or may be image data indicating an image. In the following description, the information for causing the presenter U_PC to determine whether or not to approve the communication between the smartphone 20_1 and the projector 30 is assumed to be image data indicating an image, and may be referred to as "communication determination image data". The smartphone 20_1 logs in to the projector 30 when the projector 30 receives information indicating that communication between the smartphone 20_1 and the projector 30 is approved from the PC 10 via the wired cable CB. Since an image indicated by the communication determination image data is not displayed on the projection region PR, the presenter U_PC can smoothly proceed with the explanation about the image GP. Operation of the display system 1 will be described with reference to FIGS. 5 and 6.

### 1-3. Operation of display system 1

FIG. 5 is a sequence diagram for explaining an example of the operation of the display system 1. FIG. 6 is a flowchart showing an example of operation of the projector 30. In FIG. 5, the description will be made on the assumption that the smartphones 20 included in the display system 1 are the smartphone 20_1 and the smartphone 20_2. In the first embodiment, management authority of the projector 30 is set to the PC 10 that has established communication with the projector 30 and to the smartphone 20 that logs in to the projector 30. Then, the projector 30 causes the presenter U of the PC 10 or the smartphone 20 to which management authority is set to determine whether or not to approve communication with the projector 30. In the following description, the PC 10 and the smartphone 20 for which management authority is set may be referred to as a "management authority device". The value that the number of management authority devices can take is an integer of 0 or more.

In the following description, the PC 10 corresponds to a "first device", the smartphone 20_1 corresponds to a "second device", and the smartphone 20_2 corresponds to a "third device". Communication between the PC 10 and the projector 30 corresponds to "first communication". Communication between the smartphone 20_1 and the projector 30 corresponds to "second communication". Communication between the smartphone 20_2 and the projector 30 corresponds to "third communication".

The processing circuit 31 of the projector 30 reads the communication control program PRM from the storage circuit 32 and executes the read communication control program PRM, thereby performing operations shown in FIGS. 5 and 6. The processing circuit 11 of the PC 10 reads the projector communication control program PRJ1 from the storage circuit 12 and executes the read projector communication control program PRJ1, thereby performing the operations shown in FIG. 5. The processing circuit 21 of the smartphone 20 reads the projector communication control program PRJ2 from the storage circuit 22 and executes the read projector communication control program PRJ2, thereby performing the operation shown in FIG. 5.

As shown in FIGS. 5 and 6, in step SP2 the processing circuit 31 projects an identification code image including an identification code on the projection region PR after the power is turned on. The identification code is, for example, a character string having a plurality of alphanumeric characters. Then, as shown in FIG. 6, in step SP4 the processing circuit 31 determines whether or not there was an instruction to turn power off by, for example, a power button of the projector 30 being pressed. If the determination result of step SP4 is positive, the processing circuit 31 ends the series of processes shown in FIG. 6.

If the determination result of step SP4 is negative, the processing circuit 31 determines whether or not the wired cable CB is electrically connected in step SP6 as shown in FIG. 6. If the determination result of step SP6 is positive, the PC 10 and the projector 30 execute a wired communication establishment process in step SP8, and communication between the PC 10 and the projector 30 is established. After the process of step SP8 is completed, in step SP10 the processing circuit 31 sets management authority to a device with which communication was established by wired communication, that is, the PC 10 in the example of FIG. 5. After completing the process of step SP10, the processing circuit 31 executes the process of step SP4 again.

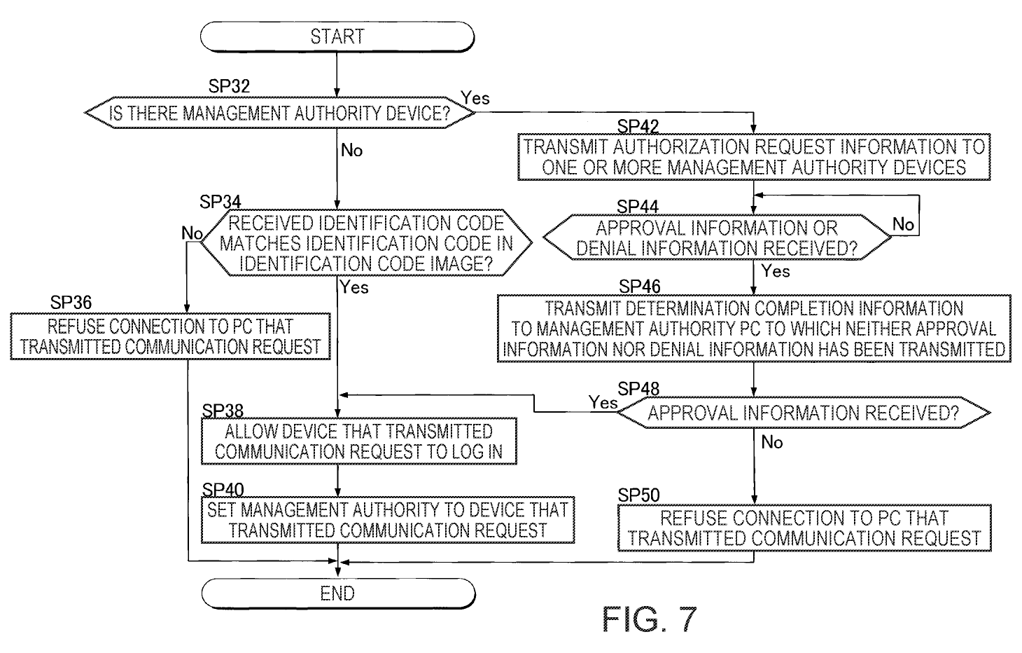

If the determination result of step SP6 is negative, then as shown in FIG. 6, the processing circuit 31 determines whether or not a communication request was received by wireless communication in step SP12. If the determination result of step SP12 is positive, then in step SP14 as shown in FIG. 6, the processing circuit 31 executes a process for when a communication request is received. The process for when a communication request is received will be described with reference to FIG. 7.

FIG. 7 is a flowchart showing an example of the process for when a communication request is received. In step SP32, the processing circuit 31 determines whether or not there is a management authority device. When the determination result of step SP32 is negative is a case where the projector 30 receives the communication request by wireless communication in a state where there is no management authority device. Hereinafter, a process in a case where the determination result of step SP32 is negative will be described.

If the determination result of step SP32 is negative, then as shown in FIG. 7, in step SP34, it is determined whether or not an identification code included in the received communication request matches an identification code included in an identification code image. If the determination result of step SP34 is negative, then in step SP36, the processing circuit 31 refuses the connection to the device that transmitted the communication request, and ends the series of processes shown in FIG. 6. The wireless communication circuit 34 transmits a refusal response to the device that transmitted the communication request, as an example of refusal of the connection to the device, under the instruction of the processing circuit 31. The refusal response includes, for example, an identifier indicating that an identification code input by a user is incorrect.

If the determination result in step SP34 is positive, then as shown in FIG. 7, the processing circuit 31 allows the device that transmitted the communication request to log in in step SP38, and the device that transmitted the communication request logs in to the projector 30. Next, as shown in FIG. 7, the processing circuit 31 sets management authority to the device that transmitted the communication request in step SP40, and ends the series of processes shown in FIG. 7.

The description will return to FIGS. 5 and 6. In the example shown in FIG. 5, the description will be made on the premise that, after the wired communication establishment process is performed, the PC 10 starts transmitting image data to the projector 30 in step SC4. Specifically, the PC 10 transmits image data to the projector 30 via the first wiring WR1 of the wired cable CB.

If the determination result of step SP12 is negative, then as shown in FIG. 6, in step SP16, the processing circuit 31 determines whether or not reception of image data has started. If the determination result of step SP16 is positive, then as shown in FIGS. 5 and 6, in step SP18, the projection device 37 starts projecting an image based on the received image data based on the instruction of the processing circuit 31. The image based on image data may be an image itself indicated by the image data, a partial image of the image indicated by the image data, or an image in which another image is superimposed on the image that was indicated by the image data or by the partial image of the image. The other image is, for example, a character string indicating the current time, or an OSD image in which a position and contrast of the image can be operated. OSD is an abbreviation for on screen display.

It should be noted that in step SP18, in a case in which image data is received from two or more devices, the projection device 37 projects an image based on the image data received from each of the two or more devices into each of divided regions of the projection region PR. After completing the process of step SP18, the processing circuit 31 executes the process of step SP4 again.

If the determination result of step SP16 is negative, then as shown in FIG. 6, in step SP20, the processing circuit 31 determines whether or not reception of image data was completed. If the determination result of step SP20 is positive, then as shown in FIG. 6, in step SP22 the projection device 37 ends projection of the image based on the received image data based on the instruction of the processing circuit 31.

In step SP22, in a case in which image data is received from three or more devices, and reception of image data from one device is completed, the projection device 37 projects an image based on image data received from each of two or more devices after reducing the number of divisions of the projection region PR. When image data is received from two devices and reception of image data from one of the devices is completed, the projection device 37 cancels the division of the projection region PR and projects an image based on the image data received from the remaining one of the devices.

After completing the process of step SP22, the processing circuit 31 executes the process of step SP4 again. If the determination result of step SP20 is negative, the processing circuit 31 executes the process of step SP4 again.

In FIG. 5, the description will be made on the premise that the smartphone 20_1 transmits a communication request for the projector 30 to the projector 30 in step SP18 after the projection device 37 starts projecting an image in step SS2. Accordingly, the processing circuit 31 determines that the determination result of step SP12 is positive and, because there is one device, the PC 10, for which management authority was set, further determines that the determination result of step SP32 in FIG. 7 is positive.

The description returns to FIGS. 5 and 7. If the determination result of step SP32 is positive, then in step SP42, at least one of the wireless communication circuit 34 and the wired communication circuit 35 transmits authorization request information to one or more management authority devices under the instruction of the processing circuit 31. In the example of FIG. 5, the wired communication circuit 35 transmits the authorization request information to the PC 10, which is the management authority device, via the second wiring WR2 of the wired cable CB under the instruction of the processing circuit 31. The authorization request information is information indicating that the smartphone 20_1 has requested communication with the projector 30, and is information necessary for the presenter U_PC to determine whether or not to approve the communication between the smartphone 20_1 and the projector 30. The authorization request information is, for example, information related to the smartphone 20_1 that transmitted a communication request to the projector 30. For example, the authorization request information includes the name of the smartphone 20_1 that requested allowing communication and the account ID currently logged in to the smartphone 20_1. ID is an abbreviation for identification.

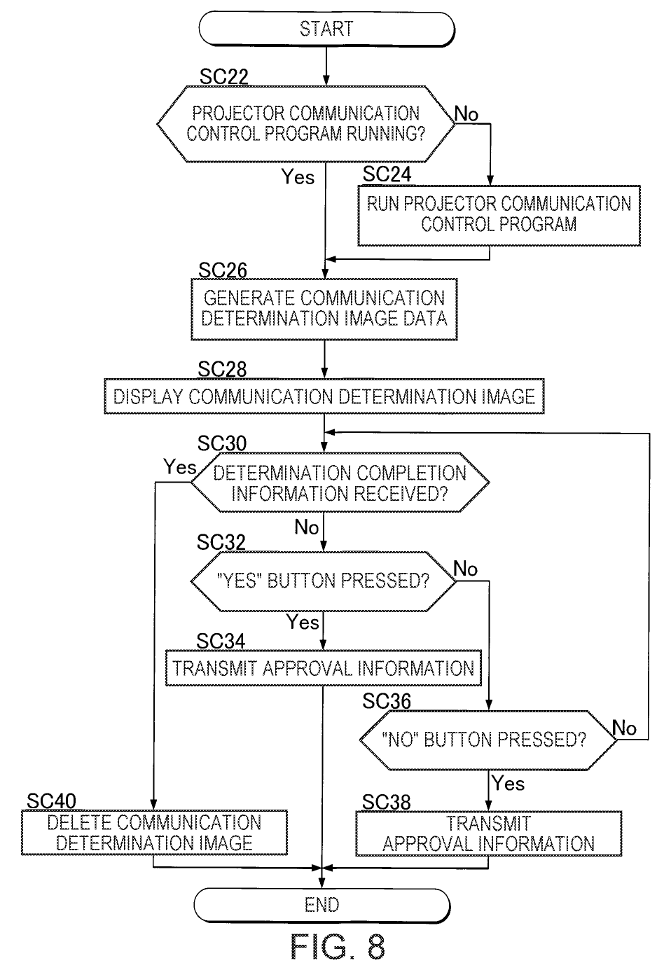

The processing circuit 11 of the PC 10 that received the authorization request information executes a process for when authorization request information is received in step SC8 as shown in FIG. 5. Note that a processing circuit 21_x of a smartphone 20_x may also execute the process for when authorization request information is received when the smartphone 20_x is the management authority device. The reference symbol x is an integer from 1 to N. The process for when authorization request information is received will be described with reference to FIG. 8.

FIG. 8 is a flowchart showing an example of the process for when authorization request information is received. The flowchart shown in FIG. 8 will be described below using an example in which the processing circuit 11 executes the process for when authorization request information is received. In step SC22, the processing circuit 11 determines whether or not the projector communication control program PRJ1 is running by an execution code of the control program PR1.

A reason for checking whether the projector communication control program PRJ1 is running or not is that even if the projector communication control program PRJ1 is not running, image data indicating the image GP displayed on the display section 17 of the PC 10 is transferred via the wired cable CB, and the projector 30 projects the image GC indicated by this image data. However, among the series of processes shown in FIG. 8, processes from step SC26 onwards are realized by the processing circuit 11 executing an execution code of the projector communication control program PRJ1. Therefore, in the first embodiment, if the projector communication control program PRJ1 is not running, it is necessary to run the projector communication control program PRJ1. If the determination result of step SC22 is negative, the processing circuit 11 runs the projector communication control program PRJ1 in step SC24.

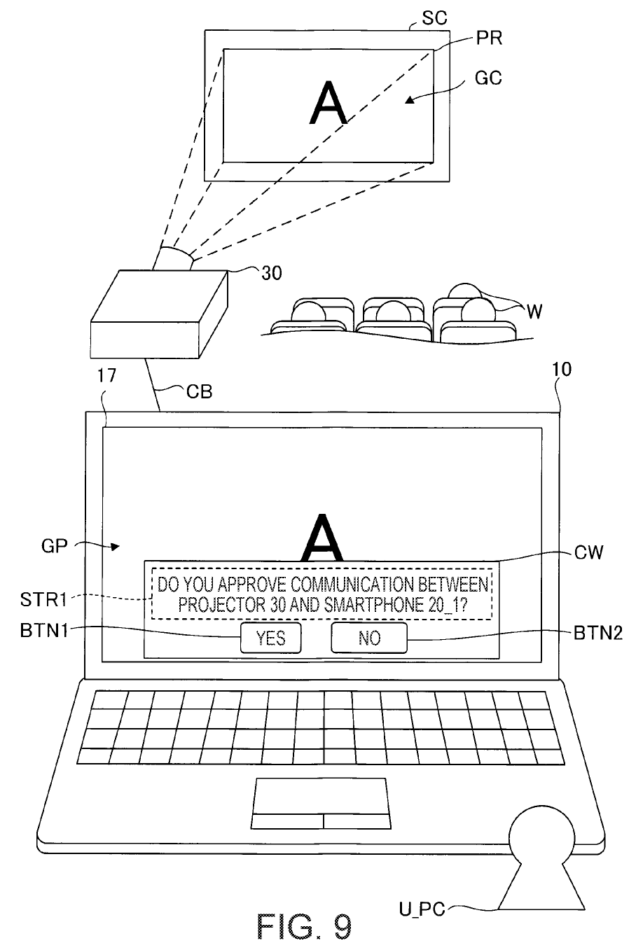

After the process of step SC24 is completed, or if the determination result of step SC22 is positive, the processing circuit 11 generates a communication determination image data based on the authorization request information by the execution code of the projector communication control program PRJ1 in step SC26. In the process for when authorization request information is received, the processes from step SC26 onwards are performed by the execution code of the projector communication control program PRJ1. After completing the process of step SC26, in step SC28 the processing circuit 11 causes the display section 17 to display the communication determination image CW indicated by communication determination image data. A display example of the communication determination image CW will be described with reference to FIG. 9.

FIG. 9 is a diagram showing an example of the communication determination image CW. As shown in FIG. 9, the display section 17 superimposes the communication determination image CW on the image GP. In the example of FIG. 9, the communication determination image CW includes a character string STR1, a button BTN1, and a button BTN2. The character string STR1 is "DO YOU APPROVE COMMUNICATION BETWEEN PROJECTOR 30 AND SMARTPHONE 20_1?". The button BTN1 marked with "YES" is a button that, when pressed by the presenter U_PC, transmits approval information indicating that communication with the projector 30 was approved to the projector 30 via the wired cable CB. The button BTN2 marked with "NO" is a button that transmits to the projector 30, via the wired cable CB, denial information indicating that communication with the projector 30 has been denied.

As shown in FIG. 9, the communication determination image CW is displayed on the display section 17, but is not projected on the projection region PR.

The description returns to FIG. 8. After the process of step SC28 is completed, the processing circuit 11 determines in step SC30 whether or not determination completion information was received from the projector 30. The determination completion information is information indicating that the determination of whether or not to approve communication was completed. A case where the determination result of step SC30 is positive will be described later. If the determination result of step SC30 is negative, the processing circuit 11 determines in step SC32 whether or not the button BTN1 marked with "YES" has been pressed. When the determination result of step SC32 is positive, the processing circuit 11 transmits the approval information to the projector 30 via the second wiring WR2 of the wired cable CB in step SC34. After the process of step SC34 is completed, the processing circuit 11 ends the series of processes shown in FIG. 8.

If the determination result of step SC32 is negative, the processing circuit 11 determines whether or not the button BTN2 marked with "NO" is pressed in step SC36. If the determination result of step SC36 is negative, the processing circuit 11 returns the process to step SC30. On the other hand, when the determination result of step SC36 is positive, the processing circuit 11 transmits denial information to the projector 30 via the second wiring WR2 of the wired cable CB in step SC36. After the process of step SC38 is completed, the processing circuit 11 ends the series of processes shown in FIG. 8.

The description returns to FIGS. 5 and 7. In the example of FIG. 5, it is assumed that the button BTN1 of the PC 10 is pressed by the presenter U_PC. Therefore, as shown in FIG. 5, the processing circuit 11 executes the process of step SC32.

After completing the process of step SP42, the processing circuit 31 determines in step SP44, as shown in FIG. 7, whether or not approval information or denial information was received from any of one or more management authority devices. If the determination result of step SP44 is negative, the processing circuit 31 executes the process of step SP44 again. In the example of FIG. 5, it is assumed that the button BTN1 is pressed by the presenter U_PC, and the PC 10 transmits the approval information to the projector 30 in step SC32. Accordingly, the processing circuit 31 determines that the determination result of step SP44 is positive.

If the determination result of step SP44 is positive, then under the instruction of the processing circuit 31, in step SP46, at least one of the wireless communication circuit 34 and the wired communication circuit 35 transmits determination completion information to, among the management authority devices to which authorization request information was transmitted, the management authority device to which neither approval information nor denial information has been transmitted. If there is a management authority device that has not received either approval information or the denial information, the projector 30 determines that the management authority device has not transmitted any of the approval information and the denial information. Immediately after the PC 10 transmits first approval information, there is only one management authority device, and there is no management authority device that has not transmitted either approval information or the denial information. Therefore, the processing circuit 31 does not execute substantial processing in step SP46.

After the process of step SP46 is completed, the processing circuit 31 determines in step SP48 whether or not the approval information was received. If the determination result of step SP48 is positive, the processing circuit 31 executes the process of step SP38, and in the example of FIG. 5, allows the smartphone 20_1 to log in.

If the determination result of step SP48 is negative, that is, if the denial information is received, the processing circuit 31 refuses connection to the device that transmitted the communication request in step SP50 as shown in FIG. 7, and ends the series of processes shown in FIG. 7. The process of step SP50 is the same as the process of step SP36, but a content of a refusal response of step SP50 may be different from a content of a refusal response of step SP36. The refusal response of step SP50 includes, for example, an identifier indicating that the communication is denied by a user of the PC 10 having the management authority of the projector 30.

In the example shown in FIG. 5, it is assumed that the processing circuit 31 executes the process of step SP38, the smartphone 20_1 logs in to the projector 30, and then in step SS12, the smartphone 20_2 transmits a communication request to the projector 30.

When the communication request is received, the processing circuit 21 determines that determination results of step SP12 and step SP32 are positive. Then, at least one of the wireless communication circuit 34 and the wired communication circuit 35 transmits authorization request information to one or more management authority devices under the instruction of the processing circuit 31 in step SP42. After the smartphone 20_2 transmits the communication request, there are two management authority devices, that is, the PC 10 and the smartphone 20_1. Therefore, in step SP42, the wired communication circuit 35 transmits authorization request information to the PC 10 via the second wiring WR2 of the wired cable CB under the instruction of the processing circuit 31, and the wireless communication circuit 34 transmits authorization request information to the smartphone 20_1 under the instruction of the processing circuit 31.

When authorization request information is received, the processing circuit 11 of the PC 10 and a processing circuit 21_1 of the smartphone 20_1 execute a process for when authorization request information is received. In the example of FIG. 5, the description will be made on the premise that the processing circuit 11 of the PC 10 transmits approval information to the projector 30 based on an operation of the presenter U_PC and that the smartphone 20_1 transmits neither approval information nor denial information. Therefore, as shown in FIG. 5, the wireless communication circuit 34 transmits determination completion information to the smartphone 20_1 under the instruction of the processing circuit 21 in step SP46.

When determination completion information was received, the processing circuit 21_1 determines that the determination result of step SC30 is positive as shown in FIG. 8. When the determination result of step SC30 is positive, the processing circuit 21_1 deletes the communication determination image CW in step SC40. After the process of step SC40 is completed, the processing circuit 21_1 ends the series of processes shown in FIG. 8.

After transmitting the determination completion information, as shown in FIGS. 5 and 7, in step SP38 the processing circuit 31 of the projector 30 allows the smartphone 20_2, which is a device that transmitted the communication request, to log in, and the smartphone 20_2 logs in to the projector 30.

In FIG. 5, the projector 30 transmits the determination completion information to the smartphone 20_1 and then allows the smartphone 20_2 to log in, however, the projector 30 may transmit the determination completion information to the smartphone 20_1 after allowing the smartphone 20_2 to log in.

### 1-4. Recap of first embodiment

In the following description, communication between the PC 10 and the projector 30 is referred to as first communication, communication between the smartphone 20_1 and the projector 30 is referred to as second communication, and communication between the smartphone 20_2 and the projector 30 is referred to as third communication, and a recap of the first embodiment will be described.

The display system 1 in the first embodiment is a system including the projector 30 capable of communicating with the PC 10 and the one or more smartphones 20. Further, the display system 1 executes a method of controlling communication between the projector 30 and the smartphone 20. The projector 30, which is capable of projecting an image on the projection region PR, establishes the first communication with the PC 10 via the wired cable CB and, when the second communication between the smartphone 20_1 and the projector 30 is requested by the smartphone 20_1 while the projector 30 is displaying an image on the projection region PR, the projector 30 transmits, via the wired cable CB, the authorization request information indicating that the second communication was requested to the PC 10. When the projector 30 receives the approval information indicating that the second communication was approved from the PC 10 via the wired cable CB, the projector 30 establishes the second communication by wireless communication.

According to the first embodiment, the communication determination image CW indicated by the communication determination image data is displayed on the display section 17, but is not projected on the projection region PR, and therefore, the projection of the image GP by the projector 30 is not interfered with. Further, the smartphone 20_1 can log in to the projector 30. Therefore, according to the first embodiment, even in a situation where the projector 30 and the PC 10 are not connected by wireless communication, the smartphone 20_1 can log in to the projector 30 while suppressing interference with the display of the image GP based on image data transmitted from the PC 10 connected to the projector 30 via the wired cable CB.

Further, it is assumed that the display system 1 further includes the smartphone 20_2 capable of communicating with the projector 30 by wireless communication, and the first communication and the second communication are established. When the smartphone 20_2 requests the third communication between the smartphone 20_2 and the projector 30 while the projector 30 is displaying an image on the projection region PR, the projector 30 transmits the authorization request information indicating that the third communication has been requested to both the PC 10 and the smartphone 20_1, and when the projector 30 receives the approval information from the PC 10 or the smartphone 20_1 indicating that the third communication has been approved, the projector 30 establishes the third communication by wireless communication.

According to the first embodiment, the smartphone 20_2 can establish communication with the projector 30 while suppressing that the display of the image GP based on image data transmitted from the PC 10 or the smartphone 20 will be interfered with. Further, either the presenter U_PC or the presenter U_1 may press the button BTN1 or the button BTN2 of the communication determination image CW. Therefore, according to the first embodiment, compared to an aspect in which one presenter U presses the button BTN1 or the button BTN2 of the communication determination image CW, it is possible to suppress a delay in approval of the third communication due to a failure such as a delay in communication of the display system 1 or carelessness of the presenter U.

The wired cable CB is one wired cable, and includes the first wiring WR1 for transferring image data and the second wiring WR2 for transmitting control data. The first wiring WR1 transfers image data indicating an image displayed on the projection region PR from the PC 10, and the second wiring WR2 transfers the authorization request information indicating that the second communication has been requested from the PC 10. The authorization request information is an example of control data.

According to the first embodiment, image data and control data can be transferred between the PC 10 and the projector 30 via one wired cable CB.

In response to receiving the approval information indicating that the third communication has been approved or the denial information indicating that the third communication has been denied from one device of the PC 10 and the smartphone 20_1, the projector 30 transmits the determination completion information indicating that the determination of whether or not to approve the third communication has been completed to the other device of the PC 10 and the smartphone 20_1.

According to the first embodiment, since the determination completion information is transmitted to the other device of the PC 10 and the smartphone 20_1, the communication determination image CW displayed on the display section 17 of the other device can be deleted, and the burden of operations by the presenter U of the other device can be reduced.

In the first embodiment, in a case where the determination result of step SP44 is positive, the projector 30 transmits the determination completion information to the management authority device to which neither approval information nor denial information was transmitted in step SP46, but the disclosure is not limited to this. For example, when the projector 30 receives the approval information, the projector 30 may transmit the determination completion information to the management authority device described above after establishing communication with the device that transmitted the communication request. When the projector 30 receives denial information, the projector 30 may refuse connection with a device that transmitted the communication request, and then transmit determination completion information to the management authority device described above.

### 2. MODIFICATIONS

Each of the aspects shown above can be modified in various ways. Specific modified aspects that can be applied to the above-described embodiments will be exemplified below. Two or more aspects arbitrarily selected from the following examples may be appropriately combined as long as they do not contradict each other.

### 2-1. FIRST MODIFICATION

As described above, it is not essential that the projector communication control program PRJ1 is executed in the PC 10. Therefore, there may be a case where the projector communication control program PRJ1 is not stored in the storage circuit 12. In a first modification, an aspect in which the projector communication control program PRJ1 is not stored will be described.

### 2-1-1. Operation of first modification

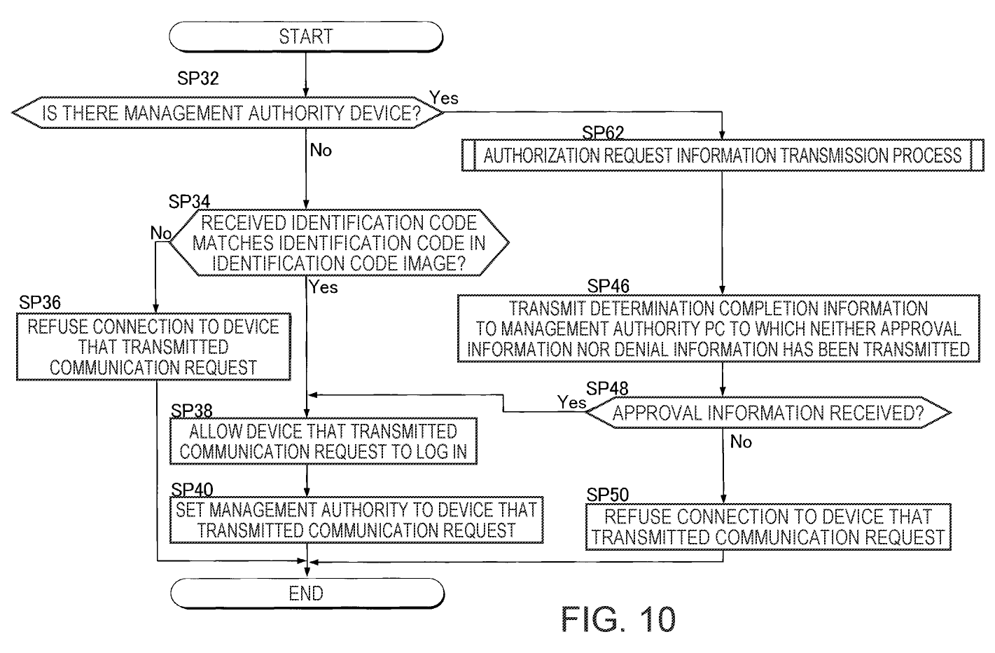

FIG. 10 is a flowchart showing an example of a process for when a communication request is received in the first modification. Comparing the flowchart in FIG. 10 with the flowchart shown in FIG. 7, the flowchart in FIG. 10 differs from the flowchart shown in FIG. 7 in that a process of step SP62 is executed instead of the processes of step SP42 and step SP44, but other parts are the same. Hereinafter, only the differences from the flowchart shown in FIG. 7 will be described.

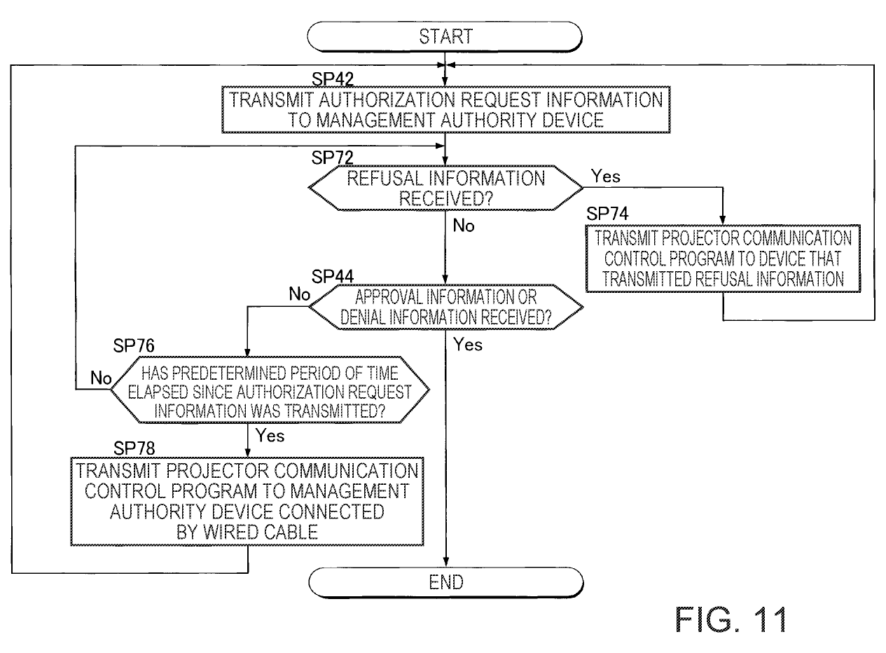

If the determination result of step SP32 is positive, the processing circuit 31 executes an authorization request information transmission process in step SP62. The authorization request information transmission process will be described with reference to FIG. 11.

FIG. 11 is a flowchart showing an example of the authorization request information transmission process. In the flowchart shown in FIG. 11, the process of step SP42 and the process of step SP44 are the same as the process of step SP42 and the process of step SP44 in the flowchart shown in FIG. 7, respectively, and therefore the description of the process is omitted. In the following description, when a step number is the same as a step number already described, it is assumed that the step has already been described, and the description thereof will be omitted.

The processing circuit 31 executes the process of step SP42. After the process of step SP42 is completed, in step SP72 the processing circuit 31 determines whether or not refusal information was received in step SP72. The refusal information is information indicating that the PC 10 that received the authorization request information does not store the projector communication control program PRJ1. If the determination result of step SP72 is positive, the processing circuit 31 transmits the projector communication control program PRJ1 to a device that transmitted the refusal information in step SP74. In order to realize the process of step SP74, the projector communication control program PRJ corresponding to a plurality of platforms is stored in the storage circuit 32 of the projector 30, and the processing circuit 31 transmits, to the PC 10, the projector communication control program PRJ that corresponds to a platform of the PC 10. Platform means an environment in which a program operates, and is specifically, for example, an OS. In order to identify the projector communication control program PRJ that corresponds to the PC 10, the PC 10 may include information indicating the platform of the PC 10 in the refusal information. The projector 30 may store the projector communication control program PRJ corresponding to a plurality of platforms in USB mass storage connected to the projector 30.

After the process of step SP74 is completed, the processing circuit 31 executes the process of step SP42 again. That is, the processing circuit 31 retransmits the authorization request information to the management authority device. If there is a management authority device other than the PC 10 and the process of step SP42 is executed again, the processing circuit 31 may or may not retransmit the authorization request information to the management authority device other than the PC 10.

If the determination result of step SP72 is negative, the processing circuit 31 executes the process of step SP44. If the determination result of step SP44 is negative, the processing circuit 31 determines in step SP76 whether or not a predetermined period of time has elapsed since the authorization request information was transmitted. If the determination result of step SP76 is negative, the processing circuit 31 executes the process of step SP72 again. If the determination result of step SP76 is positive, in step SP78 the processing circuit 31 transmits the projector communication control program PRJ to PC 10, which is the management authority device connected by the wired cable CB. After the process of step SP78 is completed, the processing circuit 31 executes the process of step SP42 again.

If the determination result of step SP44 is positive, the processing circuit 31 ends the series of processes shown in FIG. 11.

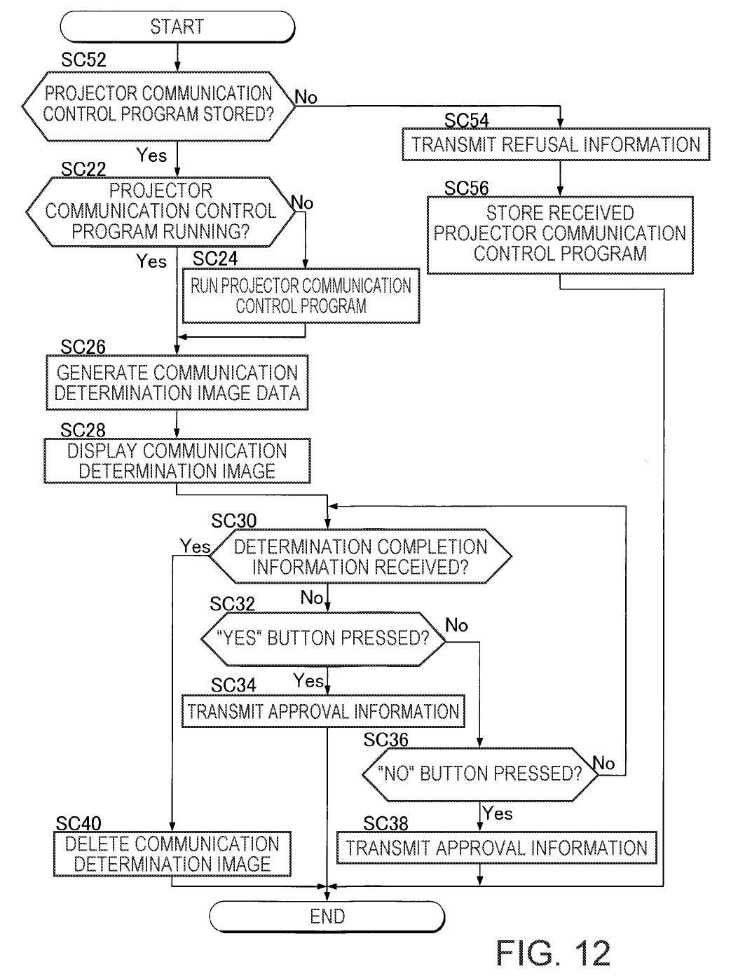

FIG. 12 is a flowchart showing an example of a process for when authorization request information is received in the first modification. Similarly to FIG. 8, the series of processes shown in FIG. 12 will be described using an example in which the processing circuit 11 executes the process for when authorization request information is received.

In step SC52, the processing circuit 11 determines whether or not the projector communication control program PRJ1 is stored in the storage circuit 12. If the determination result of step SC52 is positive, the processing circuit 11 executes the process of step SC22. If the determination result of step SC52 is negative, then in step SC54, the processing circuit 11 transmits refusal information to the projector 30 via the second wiring WR2 of the wired cable CB. In step SC56, the processing circuit 11 receives the projector communication control program PRJ1, and therefore stores the received projector communication control program PRJ1 in the storage circuit 12. After the process of step SC56 is completed, the processing circuit 11 ends the series of processes shown in FIG. 12. Note that when the processing circuit 11 ends the process for when authorization request information is received by executing the process of step SC56, the processing circuit 11 receives the authorization request information again. In the process for when authorization request information is received corresponding to the authorization request information that was received again, the processing circuit 11 determines that the determination result of step SC52 is positive.

### 2-1-2. Recap of first modification

In the following description, communication between the smartphone 20_1 and the projector 30 is referred to as the second communication, and a recap of the first modification will be described using an example in which the PC 10 is set as the management authority device.

When the PC 10 does not store the projector communication control program PRJ1 for controlling communication with the projector 30, the projector 30 stores the projector communication control program PRJ1 in the PC 10, and the approval information indicating that the second communication has been approved is transmitted to the projector 30 from the PC 10 that executed the projector communication control program PRJ1 stored in the PC 10.

According to the first modification, when the projector communication control program PRJ1 is not stored in the PC 10, the projector 30 stores the projector communication control program PRJ1 in the PC 10, thereby enabling the PC 10 connected to the projector 30 via the wired cable CB to have the presenter U_PC determine whether or not a smartphone 20 that has newly requested login is connected.

### 2-2. SECOND MODIFICATION

A second modification is different from the first embodiment and the first modification in that, when the smartphone 20, which is the management authority device, is in a mode that occupies the projection region PR to display an image, the PC 10 causes the presenter U_PC to determine the presence or absence of the connection of the smartphone 20 that has newly requested login. Hereinafter, the second modification will be described.

### 2-2-1. Operation of second modification

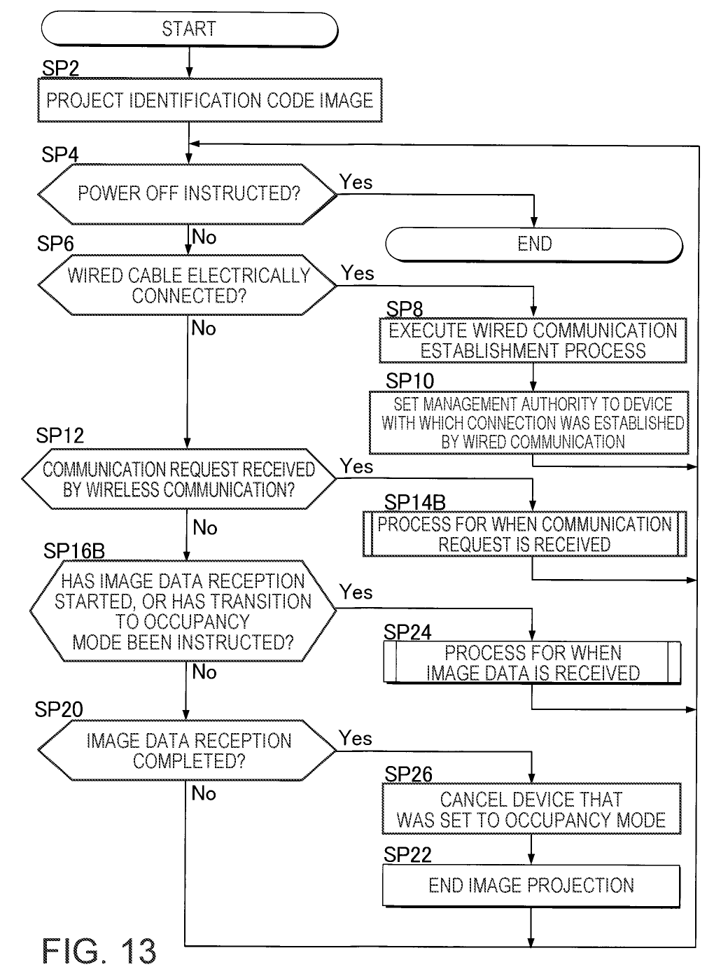

FIG. 13 is a flowchart showing an example of an operation of the projector 30 in the second modification. The flowchart shown in FIG. 13 differs from the flowchart shown in FIG. 6 in that, instead of step SP14, the flowchart executes step SP14B, instead of step SP16, the flowchart executes step SP16B, if the determination result of step SP16B is positive, the flowchart executes step SP24, and if the determination result of step SP20 is positive, the flowchart executes step SP26, however, the other parts are the same. Hereinafter, only the differences from the flowchart shown in FIG. 6 will be described. In order to facilitate understanding of the specification, processes of step SP16B, step SP24 and step SP22 will be described first, and then the process of step SP14B will be described.

If the determination result of step SP12 is negative, in step SP16B the processing circuit 31 determines whether or not reception of image data has started or the presenter U has instructed transition to an occupancy mode.

The occupancy mode is a mode in which an image based on image data transmitted from one of the PC 10 or the one or more smartphones 20 included in the display system 1 is displayed occupying the projection region PR. Note that devices to which the occupancy mode can be set are both PC 10 and the smartphone 20, but the smartphone 20 is more likely to be set to the occupancy mode than the PC 10. The reason why the PC 10 is less likely to be set to the occupancy mode than the smartphone 20 is that the PC 10 can project an image using the projector 30 without running the projector communication control program PRJ1, and therefore the PC 10 may not have activated the projector communication control program PRJ1 that can transition to the occupancy mode in the first place.

In the following description, the smartphone 20 or the PC 10 in which the occupancy mode is set may be referred to as an "occupancy device". The display section 17 or the display section 27 of the occupancy device may be referred to as a "display section of an occupancy device". Further, the presenter U of the occupancy device may be referred to as a presenter U_o. The occupancy mode is an example of a "first mode". An instruction to transition to the occupancy mode is, for example, pressing of a "transition to occupancy mode" button displayed on the display section 17 of the PC 10 and the display section 27 of the smartphone 20.

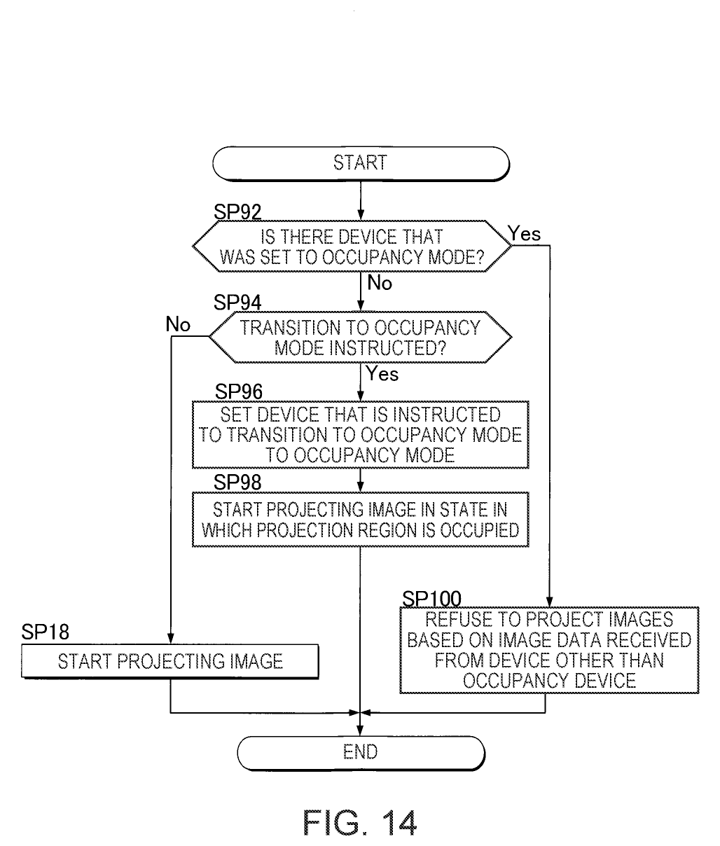

If the determination result of step SP16B is negative, the processing circuit 31 executes the process of step SP20. If the determination result of step SP16B is positive, the processing circuit 31 executes a process for when image data is received in step SP24. The process for when image data is received will be described with reference to FIG. 14.

FIG. 14 is a flowchart showing an example of the process for when image data is received. In step SP92, the processing circuit 31 determines whether or not there is a device that was set to the occupancy mode among the PC 10 and the one or more smartphones 20 included in the display system 1.

If the determination result of step SP92 is negative, the processing circuit 31 determines in step SP94 whether or not transition to the occupancy mode was instructed. If the determination result of step SP94 is negative, the processing circuit 31 executes the process of step SP18. After the process of step SP18 is completed, the processing circuit 31 ends the series of processes shown in FIG. 14.

If the determination result of step SP94 is positive, the processing circuit 21 sets the device that is instructed to transition to the occupancy mode to the occupancy mode in step SP96. Next, in step SP98, based on an instruction from the processing circuit 31, the projection device 37 starts projecting an image based on the received image data in a state in which the projection region PR is occupied. Specifically, when the projection device 37 receives image data from two or more devices, the projection device 37 cancels the division of the projection region PR and projects an image based on image data transmitted from the device set in the occupancy mode, that is, the occupancy device. After the process of step SP98 is completed, the processing circuit 31 ends the series of processes shown in FIG. 14.

If the determination result of step SP92 is positive, the processing circuit 31 refuses to project an image based on image data received from a device other than the occupancy device in step SP100. After the process of step SP100 is completed, the processing circuit 31 ends the series of processes shown in FIG. 14.

The description returns to FIG. 13. If the determination result of step SP20 is positive, then in step SP26, the processing circuit 31 cancels the PC 10 that was set to the occupancy mode. Specifically, if the device that ended reception of image data is the occupancy device, the processing circuit 31 cancels the occupancy mode. After the process of step SP26 is completed, the processing circuit 31 executes step SP22.

In order to avoid complication of the drawing, in FIG. 13, a case where the presenter U_o of the occupancy device instructs to cancel the occupancy mode is not shown. When the presenter U_o instructs the projector 30 to cancel the occupancy mode, the projector 30 cancels the device that was set to the occupancy mode. An instruction to cancel the occupancy mode is, for example, pressing of a "cancel occupancy mode" button displayed on a display section of the occupancy device. When image data is received from two or more devices as a result of cancellation of the occupancy mode, the projection device 37 projects an image based on image data received from each of two or more devices on each of regions obtained by dividing the projection region PR.

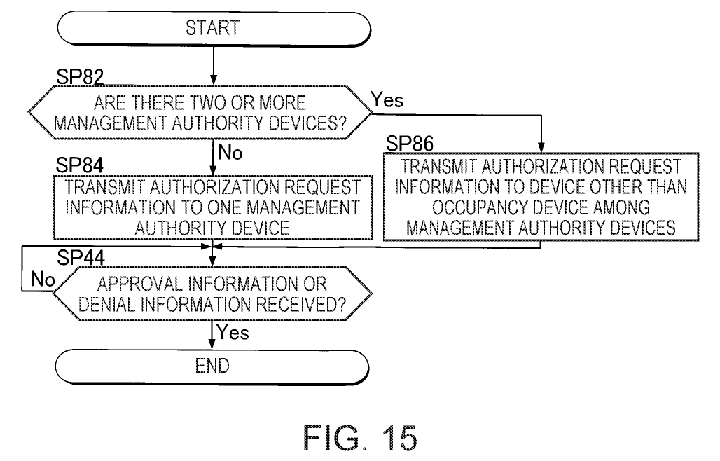

When the determination result of step SP12 is positive, the processing circuit 31 executes a process for when a communication request is received in the second modification in step SP14B. The process for when a communication request is received in the second modification is different from the process for when a communication request is received in the first modification in that an authorization request information transmission process is executed in the second modification instead of the authorization request information transmission process in the first modification, and is the same in other points, and thus, the description thereof will be omitted. The authorization request information transmission process in the second modification will be described with reference to FIG. 15.

FIG. 15 is a flowchart showing the authorization request information transmission process in the second modification. In step SP82, the processing circuit 31 determines whether or not there are two or more management authority devices. If the determination result of step SP82 is negative, the processing circuit 31 transmits authorization request information to one management authority device in step SP84. On the other hand, when the determination result of step SP82 is positive, then in step SP86 the processing circuit 31 transmits authorization request information to a device other than the occupancy device among the management authority devices.

After the process of step SP84 or the process of step SP86 is completed, the processing circuit 31 executes the process of step SP44.

The description returns to FIG. 13. After the process of step SP14B is completed, the processing circuit 31 returns the process to step SP4.

### 2-2-2. Recap of second modification

In the following description, communication between the smartphone 20_2 and the projector 30 is referred to as third communication, and a recap of the second modification will be described using an example in which the PC 10 and the smartphone 20_1 are set as the management authority devices.

The smartphone 20_1 is set to the occupancy mode in which an image based on image data transmitted from the smartphone 20_1 is displayed occupying the projection region PR, and when the projector 30 receives a request for the third communication from the smartphone 20_2 while displaying an image on the projection region PR, the projector 30 transmits information indicating that the third communication has been requested to the PC 10 via the wired cable CB, and when the projector 30 receives information indicating that the third communication has been approved from the PC 10 via the wired cable CB, then the projector 30 establishes the third communication by wireless communication.

According to the second modification, the display section 17 of the PC 10 that is not projecting an image using the projector 30 displays the communication determination image CW indicated by the communication determination image data, thereby preventing the presenter U_1 of the smartphone 20_1 that is displaying an image using the projector 30 from being bothered.

### 2-3. THIRD MODIFICATION

A third modification is different from the first embodiment, the first modification, and the second modification in that the PC 10 and the smartphone 20 can set to a mode in which an image displayed by the projector 30 is not updated. Hereinafter, a third modification will be described.

### 2-3-1. Operation of third modification

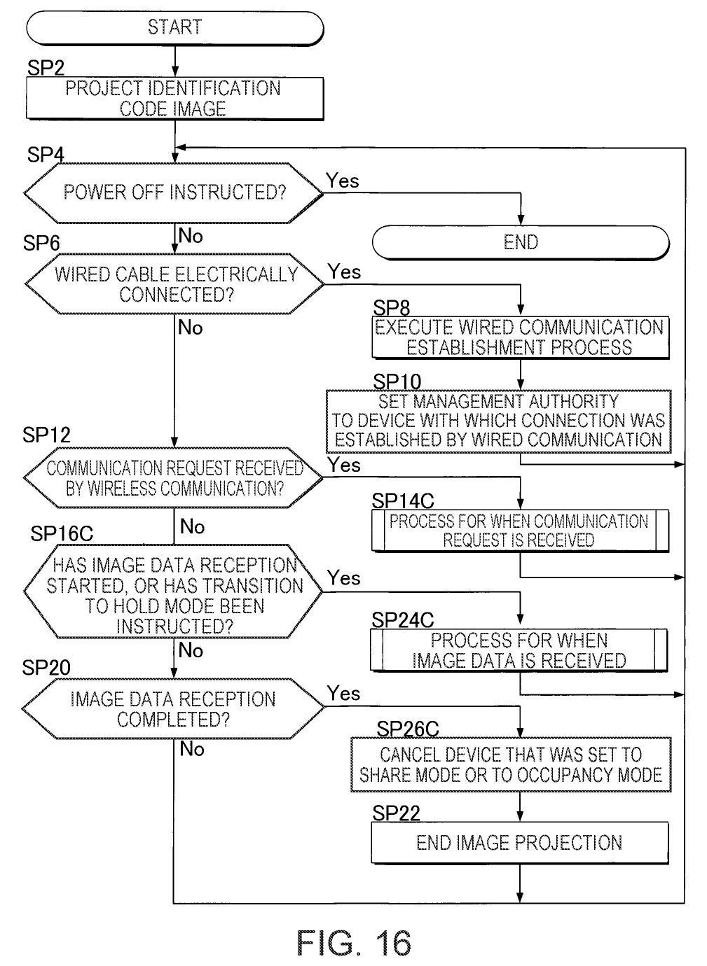

FIG. 16 is a flowchart showing an example of an operation of the projector 30 in the third modification. The flowchart shown in FIG. 16 compared to the flowchart shown in FIG. 13 differs from the flowchart of FIG. 13 in that a process in step SP14C is executed instead of the process of step SP14B, a process in step SP16C is executed instead of the process of step SP16B, a process in step SP24C is executed instead of the process of step SP24, and a process in step SP26C is executed instead of the process of step SP26, but the other parts are the same. Hereinafter, only the differences from the flowchart shown in FIG. 13 will be described. In order to facilitate understanding of the specification, the process of step SP14C will be described after the processes of step SP16C, of step SP24C, and of step SP2.

If the determination result of step SP12 is negative, the processing circuit 31 determines in step SP16C whether or not reception of image data has started, or whether or not the presenter U has instructed to transition to a hold mode.

The hold mode is a mode in which an image displayed by the projector 30 is not updated. The hold mode is useful when making a device of the presenter U execute a process that the presenter U does not want the spectator W to see while the projector 30 is displaying an image based on image data transmitted from one or more of the PC 10 and one or more smartphones 20 included in the display system 1. The process that the presenter U does not want the spectator W to see is, for example, a process of inputting personal information such as an account ID and a password.

Note that devices to which the hold mode can be set are both PC 10 and the smartphone 20, but the smartphone 20 is more likely to be set to the hold mode than the PC 10. The reason why the PC 10 is less likely to be set to the hold mode than the smartphone 20 is that the PC 10 can project an image using the projector 30 without running the projector communication control program PRJ1 as in the occupancy mode, and therefore the PC 10 may not have run the projector communication control program PRJ1 that can transition to the hold mode in the first place. Another reason why the PC 10 is less likely to be set to the hold mode is that the wired cable CB may be removed from the PC 10 when the PC 10 executes a process that the presenter U does not want the spectator W to see.

An instruction to transition to the hold mode is, for example, pressing of a "transition to hold mode" button displayed on the display section 17 of the PC 10 and the display section 27 of the smartphone 20.

The hold mode in which an image displayed by the projector 30 is not updated includes a mode in which the same image is continuously updated. In the following description, a device set to the hold mode, of the PC 10 and the smartphone 20, may be referred to as a "hold device".

In order to realize the hold mode, the projector 30 stops updating an image based on image data after the hold mode is set. In the following description, image data after the hold mode is set may be referred to as "post-hold image data".

There are three methods for realizing the hold mode as follows. In a first method of realizing the hold mode, when the hold device is instructed by the presenter U to transition to the hold mode, the hold device temporarily stops transmitting image data to the projector 30. The projector 30 continues to project an image based on image data last transmitted from the hold device. That is, in the first method of realizing the hold mode, the hold device does not transmit post-hold image data to the projector 30.

In a second method of realizing the hold mode, when the hold device is instructed by the presenter U to transition to the hold mode, the hold device temporarily stops transmitting image data to the projector 30. The projector 30 continues to project an image indicated by image data stored in advance in the storage circuit 32. That is, in the second method of realizing the hold mode, the hold device does not transmit post-hold image data to the projector 30. The image indicated by image data stored in advance in the storage circuit 32 may be any image, and is, for example, an image including a character string indicating the hold mode. The image indicated by image data stored in advance in the storage circuit 32 may be a moving image.

In a third method of realizing the hold mode, the hold device continues to transmit image data to the projector 30 even when the presenter U instructs the hold device to transition to the hold mode. The projector 30 stores image data transmitted from the hold device in the storage circuit 32 at the time when the presenter U instructs the projector 30 to transition to the hold mode, and continues to project an image based on the stored image data. That is, in the third method of realizing the hold mode, the hold device transmits the post-hold image data to the projector 30, but the projector 30 does not project an image based on the post-hold image data. In the following description, an aspect in which the first method of realizing the hold mode is adopted will be described.

In the following description, a state in which the projector 30 is caused to display an image based on image data transmitted from any one of the PC 10 and the one or more smartphones 20 may be referred to as a "share mode". Among the PC 10 and the smartphone 20, a device that is set to the share mode may be referred to as a "share-source device". The display section 17 of the PC 10 and the display section 27 of the smartphone 20, which are share-source devices, may be referred to as "display sections of share-source devices". The share mode is an example of a "second mode". The hold mode is an example of a "third mode".

In the following description, an image based on image data transmitted from a share-source device may be referred to as a "shared image". Shared images include the following two aspects. A shared image in a first aspect is the same as an image displayed on the display section of the share-source device. Hereinafter, the shared image in the first aspect may be referred to as a "mirroring image".

A shared image in a second aspect is different from an image displayed on the display section of the share-source device. Specifically, the shared image in the second aspect is an image of a part of an image displayed on the display section of the share-source device. An image of a part of an image displayed on the display section of the share-source device is, for example, an image obtained by enlarging a part of the image displayed on the display section of the share-source device, or an image in a window of an application program displayed on the display section of the share-source device. The application program may be any program, and is, for example, a program for creating a document and a program for displaying a document. Hereinafter, the shared image in the second aspect may be referred to as a "partial shared image".

Among the management authority devices, a device that is neither the share-source device nor the hold device may be referred to as an "non-shared device".

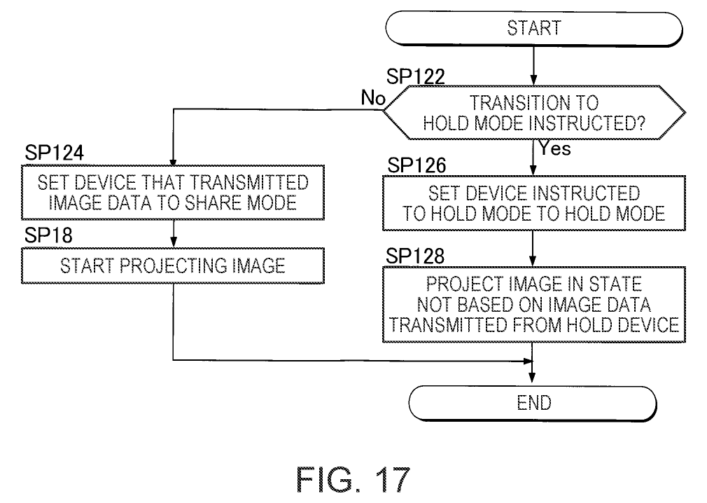

If the determination result of step SP16C is negative, the processing circuit 31 executes the process of step SP20. If the determination result of step SP16C is positive, then in step SP24C, the processing circuit 31 executes a process for when image data is received in the third modification. The process for when image data is received in the third modification will be described with reference to FIG. 17.

FIG. 17 is a flowchart showing an example operation of the process for when image data is received in the third modification. In step SP122, the processing circuit 31 determines whether or not transition to the hold mode is instructed. If the determination result of step SP122 is negative, then in step SP124, the processing circuit 31 sets a device that transmitted image data, among the PC 10 and the one or more smartphones 20, to the share mode. After the process of step SP124 is completed, the processing circuit 31 executes the process of step SP18. After the process of step SP18 is completed, the processing circuit 21 ends the series of processes shown in FIG. 17.

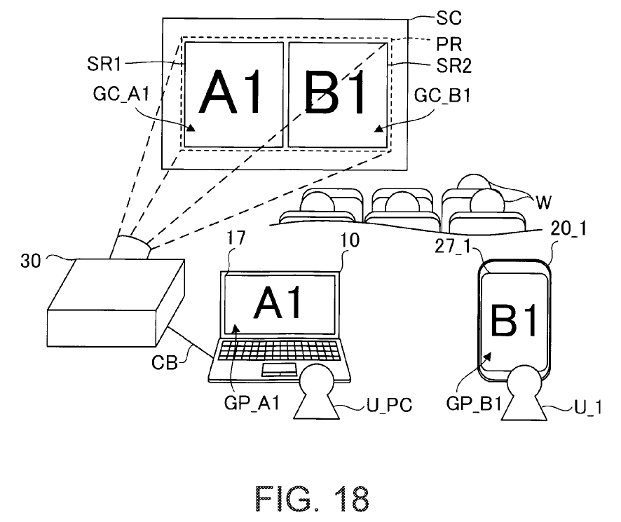

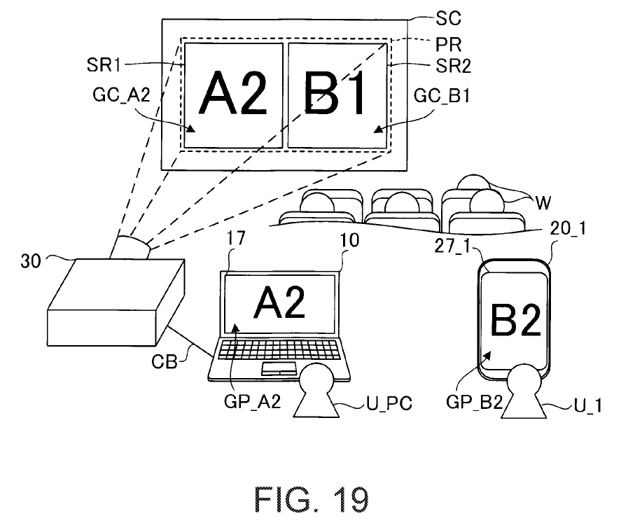

If the determination result of step SP122 is positive, the processing circuit 31 sets a device instructed to transition to the hold mode to the hold mode in step SP126. After the process of step SP126 is completed, then in step SP128, the projection device 37 projects an image in a state not based on image data transmitted from the hold device based on an instruction of the processing circuit 31. After the process of step SP128 is completed, the processing circuit 31 ends the series of processes shown in FIG. 17. A state immediately before changing to the hold mode will be described with reference to FIG. 18, and a state after changing to the hold mode will be described with reference to FIG. 19.

FIG. 18 is a diagram for explaining the state immediately before changing to the hold mode. FIG. 19 is a diagram for explaining the state after changing to the hold mode. As a premise common to FIGS. 18 and 19, the PC 10 and the smartphone 20_1 are the share-source devices. Therefore, the projector 30 divides the projection region PR into two regions, a partial region SR1 and a partial region SR2. The partial region SR1 and the partial region SR2 may be regions obtained by dividing the projection region PR into two equal parts, or may be regions obtained by dividing the projection region PR into unequal parts. Further, the projection region PR may include a region that is not included in either the partial region SR1 or the partial region SR2.

In the example of FIG. 18, the projector 30 projects an image GC_A1 based on image data transmitted from the PC 10 on the partial region SR1, and projects an image GC_B1 based on image data transmitted from the smartphone 20_1 on the partial region SR2. The image GC_A1 is the same as an image GP_A1 displayed on the display section 17. The image GC_B1 is the same as an image GP_B1 displayed on a display section 27_1 of the smartphone 20_1. As described above, in the example shown in FIG. 18, it is assumed that the shared image in the first aspect, that is, a mirroring image is projected before the mode is changed to the hold mode. The partial region SR1 is an example of a "first partial region", and the partial region SR2 is an example of a "second partial region". Image data transmitted from the PC 10 is an example of "first image data", and image data transmitted from the smartphone 20_1 is an example of "second image data".

In a state shown in FIG. 18, it is assumed that the presenter U_1 instructs the smartphone 20_1 to change the mode from the share mode to the hold mode.

In the example of FIG. 19, the projector 30 stops updating the image of the partial region SR2 based on image data after the smartphone 20_1 is set to the hold mode. Therefore, in the example shown in FIG. 19, the image displayed on the display section 27_1 is updated from image GP_B1 to image GP_B2, but the image projected on the partial region SR2 remains as the image GC_B1. On the other hand, with respect to the PC 10 that remains in the share mode, the projector 30 continues to update the image of the partial region SR1. That is, in the example shown in FIG. 19, the image displayed on the display section 17 is updated from the image GP_A1 to image GP_A2, the image projected on the partial region SR1 is updated from the image GC_A1 to image GC_A2, and the image GP_A2 and the image GC_A2 are the same as each other.

The description returns to FIG. 16. If the determination result of step SP16C is negative, the processing circuit 31 executes the process of step SP20. If the determination result of step SP20 is positive, then in step SP26C the processing circuit 31 cancels the device that was set to the share mode or to the hold mode. Specifically, the processing circuit 31 cancels the share mode when a device that has completed receiving image data is the share-source device, and cancels the hold mode when a device that has completed receiving image data is the hold device. As a result of cancellation of the hold mode, after cancellation of the hold mode, the projector 30 resumes updating the image based on image data transmitted from the device that was the hold device. After the process of step SP26C is completed, the processing circuit 21 executes step SP22.

In order to avoid complication of the drawing, in FIG. 16, a case where the presenter U of the hold device instructs to cancel the hold mode is not shown. When the presenter U of the hold device instructs the projector 30 to cancel the hold mode, the projector 30 cancels the hold mode of the hold device.

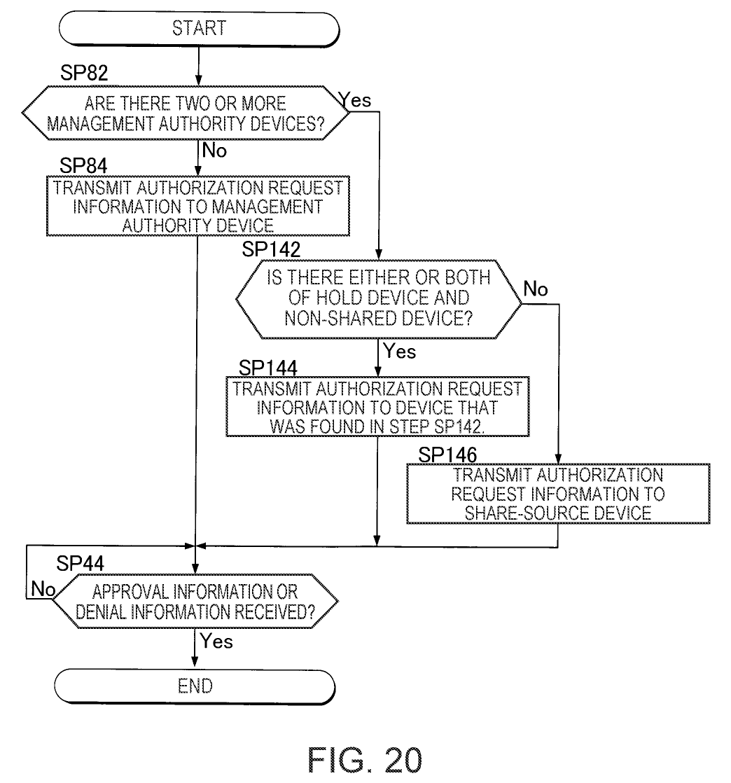

When the determination result of step SP12 is positive, then in step SP14C, the processing circuit 31 executes a process for when a communication request is received in the third modification. The process for when a communication request is received in the third modification is different from the process for when a communication request is received in the second modification in that an authorization request information transmission process in the third modification is executed instead of the authorization request information transmission process in the second modification, and is the same in other points, and thus, the description thereof will be omitted. The authorization request information transmission process in the third modification will be described with reference to FIG. 20.

FIG. 20 is a flowchart showing the authorization request information transmission process in the third modification. The processing circuit 31 executes the process of step SP82. If the determination result of step SP82 is negative, the processing circuit 31 executes the process of step SP84, and executes the process of step SP44 after the process of step SP84 is completed.

When the determination result of step SP82 is positive, then in step SP142, the processing circuit 31 determines whether or not there is either or both of a hold device and a non-shared device among the management authority devices.

If the determination result of step SP142 is positive, then in step SP144, the processing circuit 31 controls at least one of the wireless communication circuit 34 and the wired communication circuit 35 to transmit the authorization request information to the device that was found in step SP142. Specifically, when there is both a hold device and a non-shared device, the processing circuit 31 transmits the authorization request information to both the hold device and the non-shared device. When there is only a hold device, the processing circuit 31 transmits the authorization request information to the hold device. When there is only a non-shared device, the processing circuit 31 transmits the authorization request information to the non-shared device. After the process of step SP144 is completed, the processing circuit 31 executes the process of step SP44.

When the determination result of step SP142 is negative, the processing circuit 31 transmits the authorization request information to the share-source device in step SP146. After the process of step SP146 is completed, the processing circuit 31 executes the process of step SP44.

### 2-3-2. Recap of third modification

In the following description, image data transmitted from the PC 10 is referred to as the first image data, and image data transmitted from the smartphone 20_1 is referred to as the second image data. Further, in the following description, a recap of the third modification will be described using an example in which the PC 10 and the smartphone 20_1 are set as the management authority devices.

The PC 10 is set to a share mode in which an image based on image data transmitted from the PC 10 is displayed by the projector 30, and the smartphone 20_1 is set to the share mode. An image based on the first image data transmitted from the PC 10 is displayed on the partial region SR1, which is a part of the projection region PR, and an image based on the second image data transmitted from the smartphone 20_1 is displayed on the partial region SR2, which is a part of the projection region PR and which is different from the partial region SR1. When the smartphone 20_1 is set to the occupancy mode in which an image displayed by the projector 30 is not updated, the projector 30 stops updating the image of the partial region SR2 based on the second image data after the occupancy mode was set, and when the projector 30 receives a request for the third communication from the smartphone 20_2 while displaying an image on the projection region PR, the projector 30 transmits the authorization request information indicating that the third communication has been requested to the smartphone 20_1, and when the projector 30 receives the approval information from the smartphone 20_1 indicating that the third communication has been approved, the projector 30 establishes the third communication by wireless communication.

According to the third modification, by transmitting the authorization request information to the smartphone 20_1 as the hold device, it is possible to establish communication between the smartphone 20_2 and the projector 30 while suppressing interference with the display of an image displayed on the display section 17 of the PC 10. The reason why it is desirable to suppress the interference with the display of an image displayed on the display section 17 of the PC 10 is as follows. The presenter U_PC of the PC 10 may give an explanation while viewing the image displayed on the display section 17. Therefore, if the communication determination image CW were to be displayed on the display section 17, then the explanation about the image displayed on the display section 17 would be interrupted, and the presenter U_PC may feel bothered.

### 2-4. FOURTH MODIFICATION

In the first embodiment described above, the PC 10 and the smartphone 20_1 are management authority devices and, when the smartphone 20_2 requests the third communication between the smartphone 20_2 and the projector 30 while the projector 30 is displaying an image on the projection region PR, authorization request information indicating that the third communication has been requested is transmitted to both the PC 10 and the smartphone 20_1, but this is not a limitation. For example, the projector 30 may transmit authorization request information to only one of the PC 10 and the smartphone 20.

According to a fourth modification, similarly to the first embodiment, the smartphone 20_2 can establish communication with the projector 30 while suppressing that the display of the image GP based on image data transmitted from the PC 10 or the smartphone 20 will be interfered with.

### 2-5. FIFTH MODIFICATION

In each of the aspects described above, the PC 10 and the projector 30 are connected to each other by the one wired cable CB, but the disclosure is not necessarily configured this way. The PC 10 and the projector 30 may be connected to each other by two or more wired cables. For example, the PC 10 and the projector 30 may be connected to each other by a first cable for transferring image data and a second cable for transmitting control data. The first cable is, for example, an HDMI cable, a DVI cable, or the like. DVI is an abbreviation for digital visual interface. The second cable is, for example, a USB 2.0, USB 3.0, or RS-232C cable.

### 2-6. SIXTH MODIFICATION

In each of the aspects described above, the projector 30 is an example of the "display device", but the disclosure is not limited to this. For example, as an other example of the display device, an organic EL display or a liquid crystal display may be used. EL is an abbreviation for electro luminescence.

### 2-7. SEVENTH MODIFICATION

In each of the aspects described above, the display section of the management authority device is shown as an example of an output destination of information for causing the presenter U to determine whether or not to approve communication, but the output destination is not limited to the display section of the management authority device. For example, the management authority device includes an earphone, and the presenter U wears the earphone. The management authority device may reproduce, on the earphone, a sound indicating information for causing the presenter U of the management authority device to determine whether or not to approve communication between the smartphone 20 and the projector 30, and a sound prompting approval or denial of the communication. The sound indicating information for causing the presenter U of the management authority device to determine whether or not to approve communication between the smartphone 20 and the projector 30 is, for example, "Do you approve communication between the projector 30 and the smartphone 20?". The sound prompting approval or denial of the communication is, for example, "Press the determination key if the communication is approved, and press the cancel key if the communication is denied.". When the determination key is pressed, the management authority device transmits approval information to the projector 30, and when the cancel key is pressed, the management authority device transmits denial information to the projector 30.

### 2-8. EIGHTH MODIFICATION

In each of the aspects described above, the projector 30 transmits the determination completion information to the management authority device to which both approval information and denial information are not transmitted among the management authority devices to which authorization request information is transmitted, but the determination completion information may not be transmitted.

### 3. NOTES

Hereinafter, a recap of the present disclosure is appended.

### First note

A control method of a display system including a first device, a second device, and a display device that is configured to communicate with the first device via one or more wired cables, that is configured to communicate with the second device by wireless communication, and that is configured to display an image on a display region, the control method includes establishing, by the display device, first communication with the first device via the one or more wired cables; when second communication is requested from the second device while an image is displayed on the display region, transmitting, by the display device, information indicating that the second communication between the second device and the display device was requested to the first device via the one or more wired cables; and when receiving information indicating that the second communication was approved from the first device via the one or more wired cables, establishing, by the display device, the second communication by wireless communication.

According to the first note, the display device transmits information indicating that the second communication is requested to the first device via the one or more wired cables, and receives information indicating that the second communication is approved from the first device via the one or more wired cables, thereby establishing the second communication. By this, when the display device is requested to perform the second communication, the second communication can be established even if an image including an identification code is not displayed on the display device, and the display of an image on the display region can be suppressed from being interfered with.

### Second note

The control method according to the first note, wherein the display system in which the first communication and the second communication are established further includes a third device configured to communicate with the display device by wireless communication, and further includes when third communication is requested from the third device while an image is displayed on the display region, transmitting, by the display device, information indicating that the third communication between the third device and the display device was requested to at least one of the first device and the second device and when receiving information indicating that the third communication was approved from the first device or from the second device, establishing, by the display device, the third communication by wireless communication.

According to the second note, the display device transmits information indicating that the third communication is requested to at least one of the first device and the second device, and receives information indicating that the third communication was approved from the first device or the second device, thereby establishing the third communication. By this, when the display device is requested to perform the third communication, the third communication can be established even if an image including an identification code is not displayed on the display device, and the display of an image on the display region can be suppressed from being interfered with.

### Third note

The control method according to the first note or the second note, wherein the one or more wired cables is one wired cable, the one wired cable includes a first wiring for transferring image data and a second wiring for transferring control data, the first wiring is a wiring through which image data indicating an image displayed on the display region is transferred from the first device, and the second wiring is a wiring through which information indicating that the second communication was requested is transferred from the first device.

According to the third note, the second communication is established by transferring control data and image data indicating an image displayed on the display region by one wired cable. This simplifies a configuration of the wired cable that connects the first device and the display device.

### Fourth note

The control method according to any one of the first note to the third note further includes when the first device does not store a program for controlling communication of the display device, causing, by the display device, the first device to store the program, wherein information indicating that the second communication was approved is transmitted from the first device that executed the program stored in the first device to the display device.

According to the fourth note, when a program is not stored in the first device, the display device causes the first device to store the program, thereby establishing the second communication. By this, when the display device is requested to perform the second communication in a situation where a program is not stored in the first device, the second communication can be established even if an image including an identification code is not displayed on the display device, and the display of an image in the display region can be suppressed from being interfered with.

### Fifth note

The control method according to the second note, wherein the second device is set to a first mode in which an image based on image data transmitted from the second device is displayed so as to occupy the display region and further includes when the third communication is requested from the third device while an image is displayed on the display region, transmitting, by the display device, information indicating that the third communication was requested to the first device via the one or more wired cables and when receiving information indicating that the third communication was approved from the first device via the one or more wired cables, establishing, by the display device, the third communication by wireless communication.

According to the fifth note, when the second device is set to the first mode in which an image based on image data transmitted from the second device is displayed so as to occupy the display region, the display device transmits information indicating that the third communication was requested to the first device via the one or more wired cables, and receives information indicating that the third communication has been approved from the first device via the one or more wired cables, thereby establishing the third communication. By this, when the display device is requested to perform the third communication, the third communication can be established without causing the second device to transmit information indicating that the third communication was requested, and a user of the second device set in the first mode can be prevented from being bothered.

### Sixth note

The control method according to the second note, wherein when the first device is set to a second mode, an image based on first image data transmitted from the first device is displayed on a first partial region that is a part of the display region and when the second device is set to the second mode, an image based on second image data transmitted from the second device is displayed on a second partial region that is a part of the display region and that is different from the first partial region and further includes when the second device is set, from the second mode, to a third mode in which the second device does not update an image displayed on the display device, stopping, by the display device, update of an image of the second partial region based on the second image data after the second device is set to the third mode; when the first device is set to the second mode and the third communication is requested from the third device while the second device is set to the third mode, transmitting, by the display device to the second device, information indicating that the third communication was requested; and when receiving information indicating that the third communication was approved from the second device, establishing, by the display device, the third communication by wireless communication.

According to the sixth note, by transmitting information indicating that the third communication has been requested to the second device that is the hold device, it is possible to suppress that the display of an image displayed on the display section of the first device will be interfered with.

### Seventh note

The control method according to the second note further includes when the third communication is requested from the third device while an image is displayed on the display region, transmitting, by the display device, information indicating that the third communication was requested to the first device and the second device and in response to receiving, from one of the first device and the second device, information indicating that the third communication was approved or information indicating that the third communication was denied, transmitting, by the display device to an other of the first device and the second device, information indicating that a determination of whether or not to approve the third communication was completed.

According to the seventh note, the determination completion information is transmitted to an other of the first device and the second device, and thereby the communication determination image CW displayed on the display section of the other device is deleted. This can reduce the burden of operation of the presenter U of the other device.

### Eighth note

A display system includes a first device; a second device; and a display device configured to communicate with the first device via one or more wired cables, configured to communicate with the second device by wireless communication, and configured to display an image on a display region, wherein the display device establishes first communication with the first device via the one or more wired cables, when second communication between the second device and the display device is requested from the second device while an image is displayed on the display region, the display device transmits information indicating that the second communication was requested to the first device via the one or more wired cables, and when information indicating that the second communication was approved is received from the first device via the one or more wired cables, the display device establishes the second communication by wireless communication.

According to the eighth note, the same effect as that of the first note is obtained.

What is claimed is:

1. A control method of a display system including a first device, a second device, and a display device that is configured to communicate with the first device via one or more wired cables, that is configured to communicate with the second device by wireless communication, and that is configured to display an image on a display region, the control method comprising:
establishing, by the display device, first communication with the first device via the one or more wired cables;
when second communication is requested from the second device while an image is displayed on the display region, transmitting, by the display device, information indicating that the second communication between the second device and the display device was requested to the first device via the one or more wired cables; and
when receiving information indicating that the second communication was approved from the first device via the one or more wired cables, establishing, by the display device, the second communication by wireless communication.

2. The control method according to claim 1, wherein
the display system in which the first communication and the second communication are established further includes a third device configured to communicate with the display device by wireless communication and further comprising:
when third communication is requested from the third device while an image is displayed on the display region, transmitting, by the display device, information indicating that the third communication between the third device and the display device was requested to at least one of the first device and the second device and
when receiving information indicating that the third communication was approved from the first device or from the second device, establishing, by the display device, the third communication by wireless communication.

3. The control method according to claim 1, wherein
the one or more wired cables is one wired cable,
the one wired cable includes a first wiring for transferring image data and a second wiring for transferring control data,
the first wiring is a wiring through which image data indicating an image displayed on the display region is transferred from the first device, and
the second wiring is a wiring through which information indicating that the second communication was requested is transferred from the first device.

4. The control method according to claim 1, further comprising:
when the first device does not store a program for controlling communication of the display device, causing, by the display device, the first device to store the program, wherein
information indicating that the second communication was approved is transmitted from the first device that executed the program stored in the first device to the display device.

5. The control method according to claim 2, wherein
the second device is set to a first mode in which an image based on image data transmitted from the second device is displayed so as to occupy the display region and further comprising:
when the third communication is requested from the third device while an image is displayed on the display region, transmitting, by the display device, information indicating that the third communication was requested to the first device via the one or more wired cables and
when receiving information indicating that the third communication was approved from the first device via the one or more wired cables, establishing, by the display device, the third communication by wireless communication.

6. The control method according to claim 2, wherein
when the first device is set to a second mode, an image based on first image data transmitted from the first device is displayed on a first partial region that is a part of the display region and
when the second device is set to the second mode, an image based on second image data transmitted from the second device is displayed on a second partial region that is a part of the display region and that is different from the first partial region and further comprising:
when the second device is set, from the second mode, to a third mode in which the second device does not update an image displayed on the display device, stopping, by the display device, update of an image of the second partial region based on the second image data after the second device is set to the third mode;
when the first device is set to the second mode and the third communication is requested from the third device while the second device is set to the third mode, transmitting, by the display device to the second device, information indicating that the third communication was requested; and
when receiving information indicating that the third communication was approved from the second device, establishing, by the display device, the third communication by wireless communication.

7. The control method according to claim 2, further comprising:
when the third communication is requested from the third device while an image is displayed on the display region, transmitting, by the display device, information indicating that the third communication was requested to the first device and the second device and
in response to receiving, from one of the first device and the second device, information indicating that the third communication was approved or information indicating that the third communication was denied, transmitting, by the display device to an other of the first device and the second device, information indicating that a determination of whether or not to approve the third communication was completed.

8. A display system comprising:
a first device;
a second device; and
a display device configured to communicate with the first device via one or more wired cables, configured to communicate with the second device by wireless communication, and configured to display an image on a display region, wherein
the display device establishes first communication with the first device via the one or more wired cables,
when second communication between the second device and the display device is requested from the second device while an image is displayed on the display region, the display device transmits information indicating that the second communication was requested to the first device via the one or more wired cables, and
when information indicating that the second communication was approved is received from the first device via the one or more wired cables, the display device establishes the second communication by wireless communication.
